(19) United States
(12) Patent Application Publication
(10) Pub. No.: US 2019/0024808 A1
(43) Pub. Date: Jan. 24, 2019

(54) VALVE PART AND METHOD OF MANUFACTURING VALVE PART

(71) Applicant: AISIN AW CO., LTD., Anjo-shi, Aichi-ken (JP)

(72) Inventors: Eikichi KIDOKORO, Anjo (JP); Kaname MATSUYAMA, Anjo (JP); Kazuyuki NODA, Anjo (JP); Atsushi MORI, Anjo (JP); Katsuhiro MAENO, Anjo (JP); Takayuki OHIRA, Toyota (JP)

(73) Assignee: AISIN AW CO., LTD., Anjo-shi, Aichi-ken (JP)

(21) Appl. No.: 16/067,271

(22) PCT Filed: Feb. 27, 2017
(86) PCT No.: PCT/JP2017/007574

§ 371 Date: Jun. 29, 2018

(30) Foreign Application Priority Data
Feb. 25, 2016 (JP) 2016-034100

(51) Int. Cl. F16K 11/07; F16K 27/04; F16K 31/42; F16H 61/00

(52) U.S. Cl. CPC F16K 11/0712; F16K 27/041; F16H 61/0206; F16H 61/0021; F16H 61/0006; F16K 31/426

(57) ABSTRACT

A valve part that includes a body and a spool housing, wherein the spool housing has: a main body that has a hole that slidably houses a spool, a port formed in a wall surface of the hole of the main body and configured to vary a state of communication between an inside and an outside of the main body in accordance with a position of the spool, a communication hole that extends from the port toward a radially outer side, a first projection in which the communication hole is formed and which is formed so as to project from an outside surface of the main body toward the radially outer side, and a first opening at which the communication hole opens at a distal end of the first projection.

### BACKGROUND

The present disclosure relates to a valve part for use in a valve that has a slidable spool such as a spool valve and a solenoid valve, and to a method of manufacturing the valve part.

Hydraulic control devices for an automatic transmission that include a valve body that has a plurality of various valves such as linear solenoid valves and switching valves (hereinafter referred to simply as “valves”) and oil passages that allow communication between such valves have conventionally been widespread. While many valve bodies are made of metal such as die-cast aluminum, valve bodies made of a synthetic resin have been developed in recent years. There is known a valve attachment structure in which a sleeve (spool housing) in a cylindrical shape and made of metal and a cover (body portion) made of a synthetic resin, which are constituent members of a valve, are formed integrally with each other by injection molding such as insert molding, for example, in order to form a valve body made of a synthetic resin (see Japanese Patent Application Publication No. 2010-249307).

### SUMMARY

In the valve discussed above, however, the sleeve is in the shape of a thin-walled cylinder, and therefore may be deformed by an injection pressure of an injection material during injection molding of a resin. It is conceivable to apply a thick-walled sleeve in order to enhance rigidity so that the sleeve is not deformed. However, that causes an increase in size of the sleeve, and incurs an increase in size of the valve body.

An exemplary aspect of the disclosure provides a valve part that utilizes a spool housing with improved rigidity achieved without incurring an increase in size of a valve body, and a method of manufacturing the valve part.

The present disclosure provides a valve part including: a body made of a synthetic resin; and a spool housing provided separately from the body and embedded in the body, wherein: the body is formed so as to surround the spool housing; and the spool housing has: a main body that has a hole that slidably houses a spool, a port formed in a wall surface of the hole of the main body and configured to vary a state of communication between an inside and an outside of the main body in accordance with a position of the spool, a communication hole that extends from the port toward a radially outer side, a first projection in which the communication hole is formed and which is formed so as to project from an outside surface of the main body toward the radially outer side, and a first opening at which the communication hole opens at a distal end of the first projection.

In the present valve part, the spool housing is provided with the opening which projects from the outside surface of the main body toward the radially outer side. Thus, the opening functions as a rib of the main body, and therefore the rigidity of the spool housing can be enhanced. Therefore, the spool housing is not easily deformed even upon receiving an injection pressure of an injection material during insert molding of the spool housing, for example. Consequently, a valve part that utilizes the spool housing with improved rigidity can be obtained without incurring an increase in size of the valve body.

### BRIEF DESCRIPTION OF THE DRAWINGS

FIG. 1 is a schematic diagram illustrating a vehicle on which a hydraulic control device for an automatic transmission according to a first embodiment is mounted.

FIG. 2 is a perspective view illustrating the hydraulic control device according to the first embodiment.

FIG. 3 is a bottom view illustrating the hydraulic control device according to the first embodiment.

FIG. 4 is a sectional view illustrating a state in which the hydraulic control device is cut along the IV-IV line of FIG. 3.

FIG. 5A is a sectional view illustrating fourth to sixth layers of the hydraulic control device according to the first embodiment.

FIG. 5B is a sectional view illustrating the fourth layer of the hydraulic control device according to the first embodiment.

FIG. 6A is a schematic perspective view illustrating a sleeve according to the first embodiment.

FIG. 6B is a schematic plan view illustrating the sleeve according to the first embodiment.

FIG. 6C is a schematic side view illustrating the sleeve according to the first embodiment.

FIG. 7 is a flowchart illustrating a procedure for manufacturing the hydraulic control device according to the first embodiment.

FIG. 8A is a vertical sectional view illustrating a state in which the sleeve is mounted to a die in the procedure for manufacturing the hydraulic control device according to the first embodiment.

FIG. 8B is a vertical sectional view illustrating a state in which both end portions of the sleeve are held in the procedure for manufacturing the hydraulic control device according to the first embodiment.

FIG. 9A is a vertical sectional view illustrating a state in which the die is tightened in the procedure for manufacturing the hydraulic control device according to the first embodiment.

FIG. 9B is a vertical sectional view illustrating a state in which ports are blocked by slide pins in the procedure for manufacturing the hydraulic control device according to the first embodiment.

FIG. 10A is a schematic perspective view illustrating a sleeve according to a second embodiment.

FIG. 10B is a schematic perspective view illustrating a fourth layer of a hydraulic control device according to the second embodiment.

FIG. 11A is an enlarged vertical sectional view illustrating a port portion of the sleeve according to the first embodiment.

FIG. 11B is a transverse sectional view illustrating a state in which the sleeve according to the first embodiment is cut along the line XI to XI of FIGS. 6B and 6C.

FIG. 12A is a schematic perspective view illustrating a modified example of the sleeve according to the first embodiment.

FIG. 12B is a schematic plan view illustrating the modified example of the sleeve according to the first embodiment.

FIG. 12C is a schematic vertical sectional view illustrating the modified example of the sleeve according to the first embodiment.

FIG. 13A is a schematic perspective view illustrating a modified example of the sleeve according to the second embodiment.

FIG. 13B is a schematic plan view illustrating the modified example of the sleeve according to the second embodiment.

FIG. 13C is a schematic vertical sectional view illustrating the modified example of the sleeve according to the second embodiment.

FIG. 14 is a vertical sectional view illustrating a state in which ports are blocked by slide pins in the procedure for manufacturing the hydraulic control device according to the second embodiment.

FIG. 15A is a schematic perspective view illustrating a sleeve according to a third embodiment.

FIG. 15B is a schematic plan view illustrating the sleeve according to the third embodiment.

FIG. 15C is a schematic vertical sectional view illustrating the sleeve according to the third embodiment.

FIG. 16A is a schematic perspective view illustrating a modified example of the sleeve according to the third embodiment.

FIG. 16B is a schematic plan view illustrating the modified example of the sleeve according to the third embodiment.

FIG. 16C is a schematic vertical sectional view illustrating the modified example of the sleeve according to the third embodiment.

FIG. 17 is a schematic perspective view illustrating another modified example of the sleeve according to the third embodiment.

FIG. 18A is a sectional view illustrating a state immediately before a port is blocked by a slide pin in the procedure for manufacturing a hydraulic control device according to a fourth embodiment.

FIG. 18B is a sectional view illustrating a state in which a body portion is formed by insert molding of a sleeve according to the fourth embodiment.

FIG. 18C is a schematic sectional view illustrating a modified example of the sleeve according to the fourth embodiment.

FIG. 19 is an enlarged vertical sectional view illustrating recessed portions of the sleeve according to the first embodiment.

### DETAILED DESCRIPTION OF EMBODIMENTS

### First Embodiment

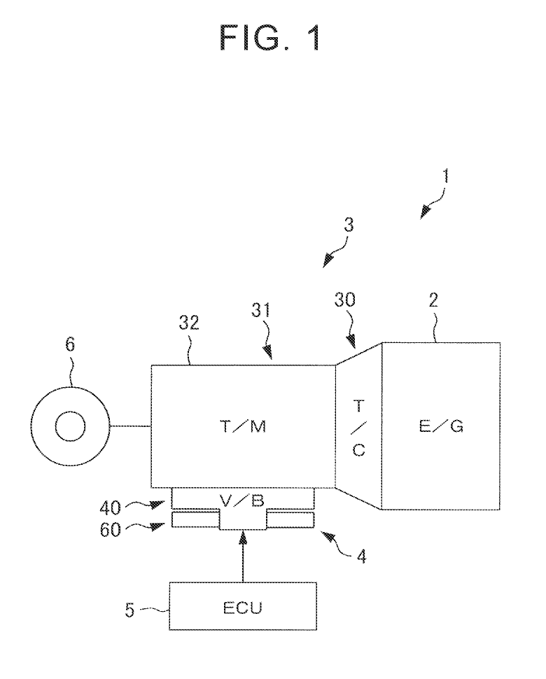

A hydraulic control device for an automatic transmission according to a first embodiment will be described below with reference to FIGS. 1 to 6C. First, a schematic configuration of a vehicle 1 on which an automatic transmission 3 is mounted as an example of a vehicle drive device will be described with reference to FIG. 1. As illustrated in FIG. 1, the vehicle 1 according to the present embodiment includes an internal combustion engine 2, the automatic transmission 3, a hydraulic control device 4 and an ECU (control device) 5 that control the automatic transmission 3, and a wheel 6, for example. The internal combustion engine 2 is an internal combustion engine such as a gasoline engine or a diesel engine, for example, and is coupled to the automatic transmission 3. In the present embodiment, the automatic transmission 3 is of a so-called FR (front-engine rear-drive) type. It should be noted, however, that the automatic transmission 3 is not limited to the FR type, and may be of an FF (front-engine front-drive) type. In addition, the same hydraulic control device 4 may be used for both the automatic transmission 3 of the FR type and an automatic transmission of the FF type. While a vehicle that utilizes only an internal combustion engine as a drive source is described as an example of the vehicle to which the vehicle drive device is applied in relation to the present embodiment, the present disclosure is not limited thereto, and the vehicle drive device may be applied to a hybrid vehicle that utilizes an internal combustion engine and an electric motor, for example, as drive sources.

The automatic transmission 3 has a torque converter 30, a speed change mechanism 31, and a transmission case 32 that houses such components. The torque converter 30 is interposed between the internal combustion engine 2 and the speed change mechanism 31, and can transfer a drive force of the internal combustion engine 2 to the speed change mechanism 31 via a working fluid. The torque converter 30 is provided with a lock-up clutch (not illustrated), and can directly transfer the drive force of the internal combustion engine 2 to the speed change mechanism 31 through engagement of the lock-up clutch. The speed change mechanism 31 is a multi-speed speed change mechanism that can establish a plurality of shift speeds in accordance with engagement and disengagement of a plurality of clutches and brakes (not illustrated). It should be noted, however, that the speed change mechanism 31 is not limited to a multi-speed transmission, and may be a continuously variable speed change mechanism such as a belt-type automatic continuously variable speed change mechanism.

The hydraulic control device 4 is constituted of a valve body, for example, and can generate a line pressure, a modulator pressure, and so forth from a hydraulic pressure supplied from an oil pump (not illustrated) to supply and discharge a hydraulic pressure for controlling the clutches and the brakes of the speed change mechanism 31 on the basis of a control signal from the ECU 5. The configuration of the hydraulic control device 4 will be discussed in detail later.

The ECU 5 includes a CPU, a ROM that stores a processing program, a RAM that temporarily stores data, input and output ports, and a communication port, for example, and outputs various types of signals, such as a control signal for the hydraulic control device 4, from the output port.

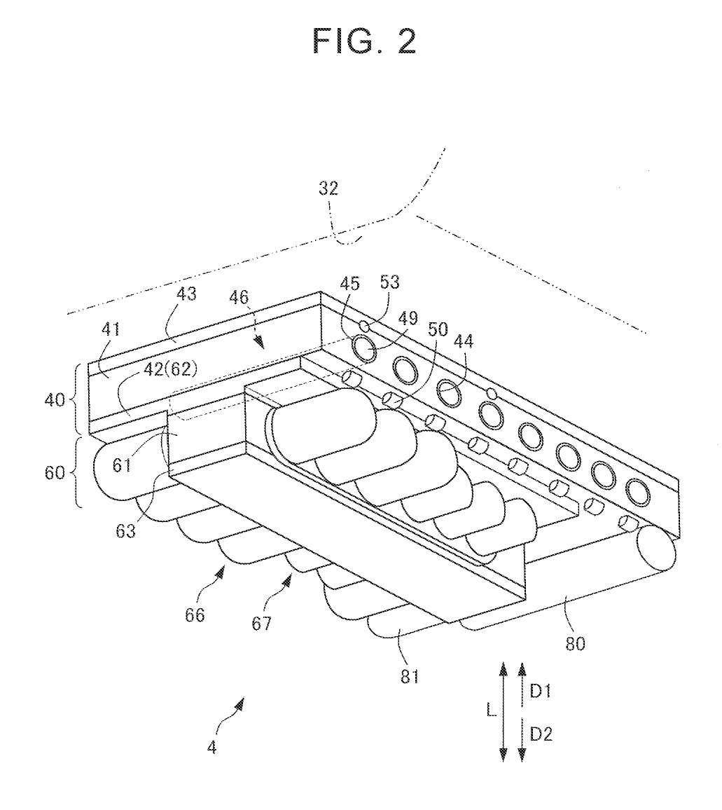

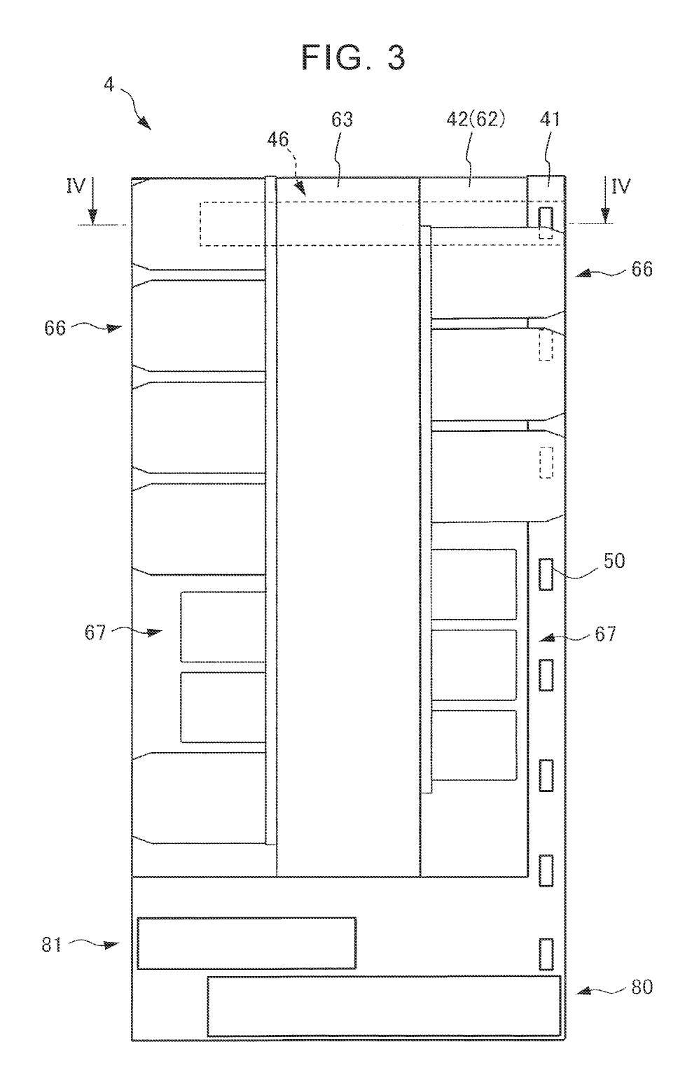

Next, the configuration of the hydraulic control device 4 discussed above will be described in detail with reference to FIGS. 2 to 6C. As illustrated in FIGS. 2 and 3, the hydraulic control device 4 includes: a valve installation section 40 attached to the transmission case 32 and provided with switching valves 46; and a solenoid installation section 60 stacked on the opposite side of the valve installation section 40 from the automatic transmission 3 and provided with linear solenoid valves 66, solenoid valves 67, and so forth. In the present embodiment, a direction in which the valve installation section 40 and the solenoid installation section 60 are stacked on each other is defined as a stacking direction L, and the stacking direction L corresponds to the up-down direction.

The valve installation section 40 includes three layers of generally plate-like blocks made of a synthetic resin, namely a first layer 41, a second layer 42, and a third layer 43, and is constituted by stacking and integrating such layers by bonding, welding, etc., for example. The valve installation section 40 is mounted to the automatic transmission 3, and can supply a hydraulic pressure to the automatic transmission 3.

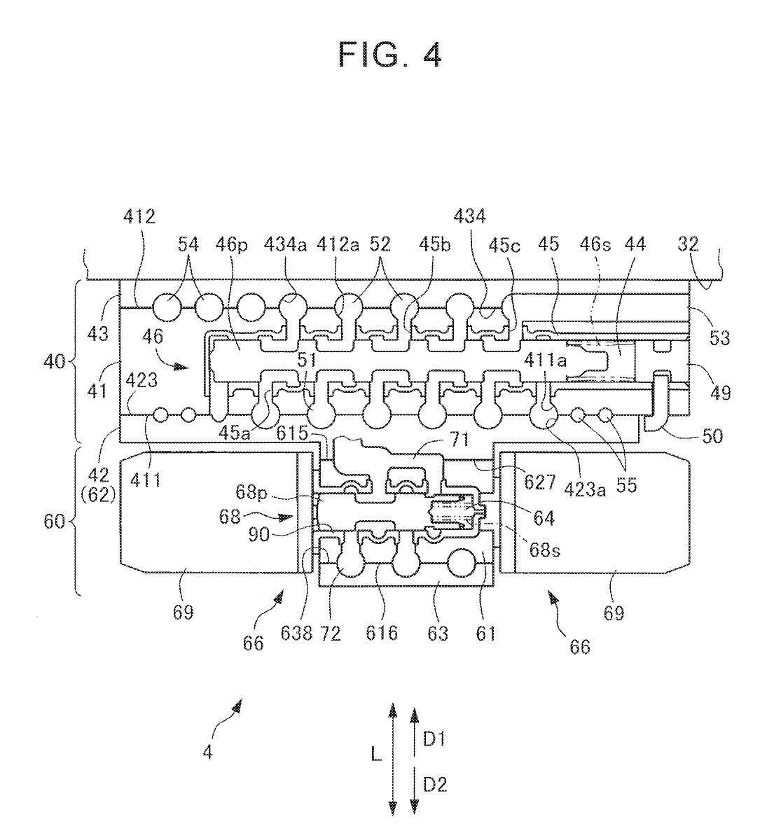

As illustrated in FIG. 4, the first layer 41 is disposed at the center of the three layers which constitute the valve installation section 40, and has a first surface 411 (first separation surface) and a second surface 412 (second separation surface) provided on the opposite sides from each other, a plurality of first hole portions 44 (i.e., first holes), a plurality of ports 45a, 45b, and 45c, a plurality of first grooves 411a, and a plurality of second grooves 412a. The plurality of first hole portions 44 are formed along the first surface 411 and the second surface 412 between the first surface 411 and the second surface 412. In the present embodiment, the first layer 41 is cast-formed by insert molding of sleeves 45 in a bottomed cylindrical shape and made of metal, and the internal spaces of the sleeves 45 are used as the first hole portions 44. A switching valve 46 which is a spool valve is formed in each of the sleeves 45. The sleeves 45 are separate from a body portion. Each of the sleeves 45 houses a spool 46p that is slidable, an urging spring 46s constituted from a compression coil spring that presses the spool 46p in one direction, and a stopper 49 that keeps a state in which the urging spring 46s presses the spool 46p, and such components form the switching valve 46. The stopper 49 is fixed in the vicinity of an opening portion of the sleeve 45 by a retainer 50.

Each of the sleeves 45 is provided with the ports 45a, 45b, and 45c, which are a large number of through holes, in the peripheral side surface. The ports 45a, 45b, and 45c are formed generally over the entire periphery, and portions of such ports other than opening portions are closed by the synthetic resin which constitutes the first layer 41. That is, the plurality of ports 45a, 45b, and 45c of the plurality of switching valves 46, each of which has the spool 46p housed in the first hole portion 44, are disposed in the first layer 41. The first grooves 411a are formed in a semi-circular cross-sectional shape in the first surface 411, and communicate with some ports 45a of the plurality of ports 45a, 45b, and 45c. The first grooves 411a form first oil passages 51 together with third grooves 423a formed in a third surface 423 (third separation surface) of the second layer 42 to be discussed later. The second grooves 412a are formed in a semi-circular cross-sectional shape in the second surface 412, and communicate with other ports 45b of the plurality of ports 45a, 45b, and 45c. The second grooves 412a form second oil passages 52 together with fourth grooves 434a formed in a fourth surface 434 (fourth separation surface) of the third layer 43 to be discussed later.

The second layer 42 is stacked on the opposite side of the first layer 41 from the transmission case 32. The second layer 42 has the third surface 423 which faces the first surface 411 of the first layer 41, and the plurality of third grooves 423a which are formed in a semi-circular cross-sectional shape in the third surface 423. The third grooves 423a face the first grooves 411a. The plurality of first oil passages 51 are formed by the plurality of first grooves 411a and the plurality of third grooves 423a with the third surface 423 stacked so as to face the first surface 411 of the first layer 41. Therefore, the first oil passages 51 communicate with some ports 45a of the plurality of ports 45a, 45b, and 45c of the switching valves 46.

The third layer 43 is stacked on the opposite side of the first layer 41 from the second layer 42, and attached to the transmission case 32. The third layer 43 has the fourth surface 434 which faces the second surface 412 of the first layer 41, and the plurality of fourth grooves 434a which are formed in a semi-circular cross-sectional shape in the fourth surface 434. The fourth grooves 434a face the second grooves 412a. The plurality of second oil passages 52 are formed by the plurality of second grooves 412a and the plurality of fourth grooves 434a with the fourth surface 434 stacked so as to face the second surface 412 of the first layer 41. Therefore, the second oil passages 52 communicate with other ports 45b of the plurality of ports 45a, 45b, and 45c of the switching valves 46.

In the present embodiment, the first oil passages 51 and the second oil passages 52 which communicate with the ports 45a and 45b which are formed in the sleeve 45 are disposed alternately along the sleeve 45. That is, at least some of the first oil passages 51 and the second oil passages 52 are disposed in a staggered manner one by one across the switching valves 46 in the stacking direction L.

The first oil passages 51 which are formed by the first layer 41 and the second layer 42 communicate with the solenoid installation section 60, or allow communication between the ports 45a in each of the switching valves 46. The first oil passages 51 which allow communication between the ports 45a in each of the switching valves 46 are formed by only the first layer 41 and the second layer 42, and are not disposed between the adjacent switching valves 46.

The second oil passages 52 which are formed by the first layer 41 and the third layer 43 communicate with the automatic transmission 3, or allow communication between the ports 45b in each of the switching valves 46. The second oil passages 52 which allow communication between the ports 45b in each of the switching valves 46 are formed by only the first layer 41 and the third layer 43, and are not disposed between the adjacent switching valves 46. That is, the oil passages 51 which allow communication between the ports 45a and the oil passages 52 which allow communication between the ports 45b in each of the switching valves 46 and 46 are formed either between the second layer 42 and the first layer 41 or between the first layer 41 and the third layer 43. Consequently, an increase in the interval between the adjacent switching valves 46 is suppressed, and an increase in size of the hydraulic control device 4 can be prevented.

In the present embodiment, in addition, an oil passage 53 that communicates with the port 45c and that extends along the longitudinal direction of the first hole portion 44 is formed by the first layer 41 and the third layer 43, for example. The oil passage 53 is exposed to a lateral end surface of the valve installation section 40, and piping (not illustrated) can be attached to the oil passage 53. Further, oil passages 54 that do not communicate with a port are formed by the first layer 41 and the third layer 43, and signal oil passages 55 etc. that do not communicate with a port and that are thinner than the oil passages 54 are formed by the first layer 41 and the second layer 42, for example. The signal oil passages 55 are utilized to supply a hydraulic pressure to be detected to a hydraulic pressure sensor etc., for example. Further, the valve installation section 40 is also provided with an oil passage (not illustrated) that penetrates the valve installation section 40 in the stacking direction L and that can supply a hydraulic pressure supplied from the solenoid installation section 60, as it is, to the automatic transmission 3.

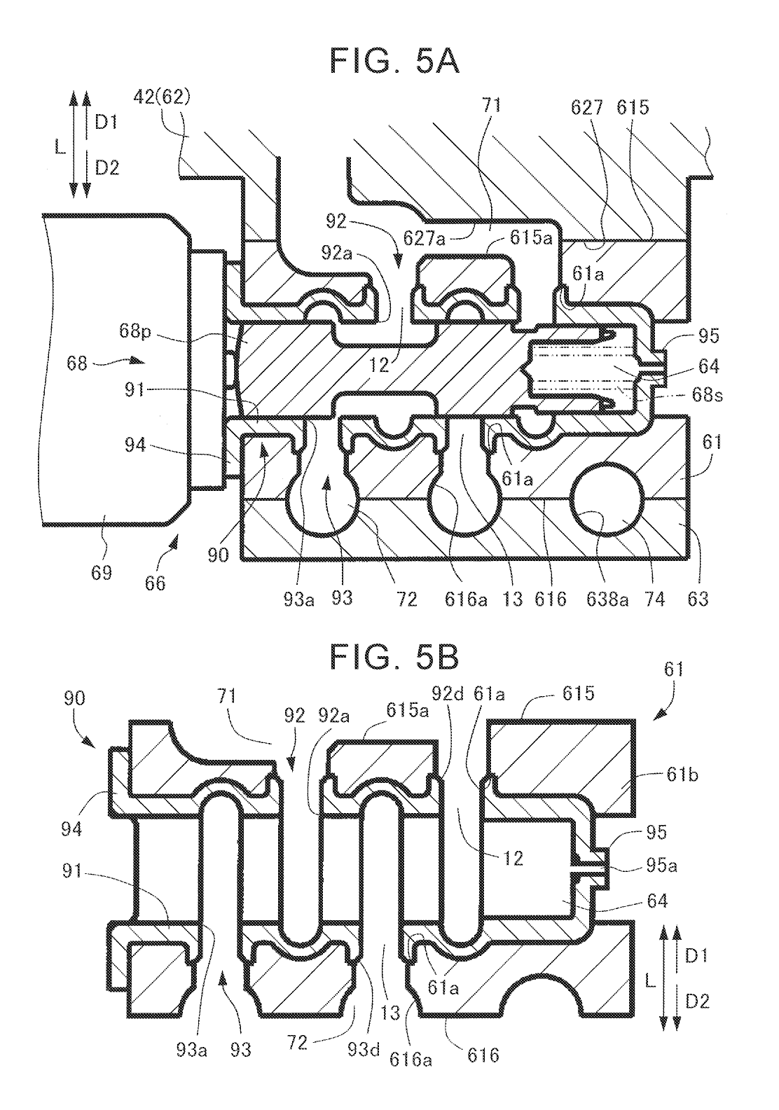

Next, as illustrated in FIGS. 4 and 5A, the solenoid installation section 60 includes three layers of generally plate-like blocks made of a synthetic resin, namely a fourth layer (valve part) 61, a fifth layer 62, and a sixth layer 63, and is constituted by stacking and integrating such layers by bonding, welding, etc., for example. The solenoid installation section 60 is stacked on the valve installation section 40, and can supply a hydraulic pressure to the valve installation section 40. In the present embodiment, the second layer 42 and the fifth layer 62 are an identical member, and have been integrated with each other. It should be noted, however, that the second layer 42 and the fifth layer 62 are not limited to being an identical member, and may be formed as separate members and integrated with each other by bonding, welding, or the like.

As illustrated in FIG. 5B, the fourth layer 61 is disposed at the center of the three layers which constitute the solenoid installation section 60, and includes sleeves (spool housings) 90 and a body portion 61b (i.e., body) formed so as to surround the sleeves 90. The fourth layer 61 has a fifth surface 615 (fifth separation surface) and a sixth surface 616 (sixth separation surface) provided on the opposite sides from each other, a plurality of second hole portions 64 (i.e., second holes), a plurality of port portions 92 and 93, a plurality of fifth grooves 615a, and a plurality of sixth grooves 616a. The plurality of second hole portions 64 are formed along the fifth surface 615 and the sixth surface 616 between the fifth surface 615 and the sixth surface 616. In the present embodiment, the fourth layer 61 is cast-formed by insert molding of the sleeves 90 in a bottomed cylindrical shape and made of metal in the body portion 61b, and the internal spaces of the sleeves 90 are used as the second hole portions (hole portions) 64. The linear solenoid valve 66 or the solenoid valve 67 (see FIGS. 2 and 3) is formed in each of the sleeves 90. That is, the sleeves 90 are separate from the body portion 61b.

Each of the sleeves 90 is provided with ports 92a and 93b, which are a large number of through holes, in the inner peripheral side surface. That is, the plurality of ports 92a and 93b of the plurality of linear solenoid valves 66, each of which has the spool 68p housed in the second hole portion 64, or solenoid valves 67 are disposed in the fourth layer 61. The configuration of the sleeve 90 will be discussed in detail later.

As illustrated in FIG. 5A, the linear solenoid valves 66 each have a pressure regulation section 68 housed in the sleeve 90 and a solenoid portion 69 that drives the pressure regulation section 68 in accordance with an electric signal. The pressure regulation section 68 has a spool 68p that is slidable in order to regulate a hydraulic pressure, and an urging spring 68s constituted from a compression coil spring that presses the spool 68p in one direction.

The fifth grooves 615a are formed in a semi-circular cross-sectional shape in the fifth surface 615, and communicate with the first ports 92a of the plurality of ports 92a and 93a. The fifth grooves 615a form third oil passages 71 together with seventh grooves 627a formed in a seventh surface 627 (seventh separation surface) of the fifth layer 62 to be discussed later. The sixth grooves 616a are formed in a semi-circular cross-sectional shape in the sixth surface 616, and communicate with the second ports 93a of the plurality of ports 92a and 93a. The sixth grooves 616a form fourth oil passages 72 together with eighth grooves 638a formed in an eighth surface 638 of the sixth layer 63 to be discussed later.

The fifth layer 62 is stacked on the transmission case 32 side of the fourth layer 61 (see FIG. 4). The fifth layer 62 has the seventh surface 627 which faces the fifth surface 615 of the fourth layer 61, and the plurality of seventh grooves 627a which are formed in a semi-circular cross-sectional shape in the seventh surface 627. The seventh grooves 627a face the fifth grooves 615a. The plurality of third oil passages 71 are formed by the plurality of fifth grooves 615a and the plurality of seventh grooves 627a with the seventh surface 627 stacked so as to face the fifth surface 615 of the fourth layer 61. Therefore, the third oil passages 71 communicate with the first ports 92a of the plurality of ports 92a and 93a of the linear solenoid valves 66 or the solenoid valves 67.

The sixth layer 63 is stacked on the opposite side of the fourth layer 61 from the fifth layer 62. The sixth layer 63 has the eighth surface 638 (eighth separation surface) which faces the sixth surface 616 of the fourth layer 61, and the plurality of eighth grooves 638a which are formed in a semi-circular cross-sectional shape in the eighth surface 638. The eighth grooves 638a face the sixth grooves 616a. The plurality of fourth oil passages 72 are formed by the plurality of sixth grooves 616a and the plurality of eighth grooves 638a with the eighth surface 638 stacked so as to face the sixth surface 616 of the fourth layer 61. Therefore, the fourth oil passages 72 communicate with the second ports 93a of the plurality of ports 92a and 93a of the linear solenoid valves 66 or the solenoid valves 67.

In the present embodiment, the third oil passage 71 and the fourth oil passages 72 which communicate with the ports 92a and 93a which are formed in the sleeve 90 are disposed alternately along the sleeve 90. That is, at least some of the third oil passages 71 and the fourth oil passages 72 are disposed in a staggered manner one by one across the linear solenoid valves 66 or the solenoid valves 67 in the stacking direction L, and disposed in a staggered manner alternately on one side and the other side in a direction (stacking direction L) that is orthogonal to the center line of the sleeve main body 91. In the present embodiment, a direction (upward direction) toward the automatic transmission 3 from the sleeve main body 91 in the stacking direction L is defined as a first direction D1, and a direction (downward direction) away from the sleeve main body 91 from the automatic transmission 3 is defined as a second direction D2.

The third oil passages 71 which are formed by the fourth layer 61 and the fifth layer 62 communicate with the valve installation section 40, or allow communication between the first ports 92a of each of the linear solenoid valves 66 and communication between the ports of the solenoid valves 67. The third oil passages 71 which allow communication between the first ports 92a of each of the linear solenoid valves 66 and communication between the ports of each of the solenoid valves 67 are formed by only the fourth layer 61 and the fifth layer 62, and are not disposed between the adjacent linear solenoid valves 66 and between the adjacent solenoid valves 67.

The fourth oil passages 72 which are formed by the fourth layer 61 and the sixth layer 63 allow communication between the second ports 93a of each of the linear solenoid valves 66 and communication between the ports of each of the solenoid valves 67. The fourth oil passages 72 which allow communication between the second ports 93a of each of the linear solenoid valves 66 and communication between the ports of each of the solenoid valves 67 are formed by only the fourth layer 61 and the sixth layer 63, and are not disposed between the adjacent linear solenoid valves 66 and the adjacent solenoid valves 67. That is, the oil passage 71 which allows communication between the ports 92a and the oil passages 72 which allow communication between the ports 93b in each of the linear solenoid valves 66 and in each of the solenoid valves 67 are formed in either between the fifth layer 62 and the fourth layer 61 or between the fourth layer 61 and the sixth layer 63. Consequently, an increase in the interval between the adjacent linear solenoid valves 66 and between the adjacent solenoid valves 67 is suppressed, and an increase in size of the hydraulic control device 4 can be prevented.

In the present embodiment, in addition, oil passages (not illustrated) that do not communicate with a port are formed by the fourth layer 61 and the fifth layer 62, and signal oil passages 74 etc. that do not communicate with a port and that are thinner than the oil passages 71 and 72 are formed by the fourth layer 61 and the sixth layer 63, for example.

In addition, in the present embodiment, as illustrated in FIGS. 2 and 3, the solenoid installation section 60 is provided with a regulator valve 80 and a modulator valve 81 that regulate a source pressure to be supplied to the linear solenoid valves 66 and the solenoid valves 67. The regulator valve 80 and the modulator valve 81 are each a spool valve that includes a spool and an urging spring (not illustrated), and communicate with the linear solenoid valves 66 and the solenoid valves 67 through the oil passages 71 and 72. The regulator valve 80 and the modulator valve 81 generate a line pressure and a modulator pressure by regulating a hydraulic pressure supplied from an oil pump (not illustrated), and supplies the line pressure and the modulator pressure to the linear solenoid valves 66 and the solenoid valves 67 as source pressures.

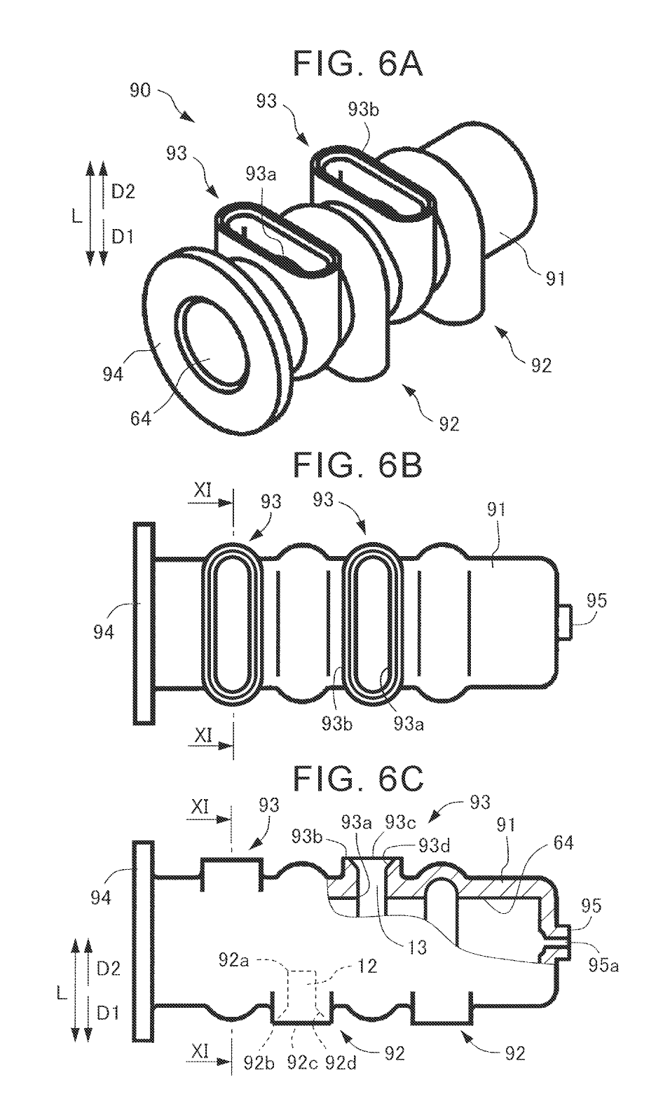

Next, the configuration of the sleeves 90 which are molded integrally with the fourth layer 61 will be described in detail with reference to FIGS. 6A, 6B, 6C, 11A, 11B, and 19. In the present embodiment, the sleeves 90 are made of metal. However, the material of the sleeves 90 is not limited thereto, and the sleeves 90 may be made of a material that is different from a synthetic resin that constitutes the body portion 61b etc. Here, the material of the sleeves 90 is a material with smaller dimensional variations than those of the material of the body portion 61b. This is because the diameter of a valve sliding portion is also varied if the dimensional variations are large, and the valve clearance becomes larger and the hydraulic pressure loss becomes larger if the diameter is increased, and the valve may stick if the diameter becomes smaller. Preferably, the material with smaller dimensional variations (1) has a small coefficient of thermal expansion, (2) does not easily creep, and (3) is not significantly swellable and does not easily absorb water or oil, or is not easily varied in volume even if the material absorbs water or oil. Metal is significantly superior to synthetic resins from the viewpoint of the above conditions (1) to (3), and the sleeves 90 are made of metal in the present embodiment.

The sleeves 90 each include a sleeve main body (main body portion/main body) 91 that has the hole portion 64 (i.e., hole) which slidably houses the spool 68p, the port portions 92 and 93, a flange portion 94 formed at an open-side end portion of the sleeve main body 91, and a projecting portion 95 formed at a bottomed closed-side end portion and having a through hole 95a that allows communication between the inside and the outside of the sleeve 90. In the present embodiment, the sleeve main body 91 is in a tubular shape, in particular a cylindrical shape. However, the shape of the sleeve main body 91 is not limited thereto. With the through hole 95a formed, air flows when the spool 68p slides inside the sleeve 90, and thus sliding motion of the spool 68p is not hindered. The port portions 92 and 93 are disposed in a staggered manner alternately on one side and the other side in a direction (stacking direction L) that is orthogonal to the center line of the sleeve main body 91. Since the port portions 92 and 93 are similar in configuration to each other, however, the port portions 93 will be described below.

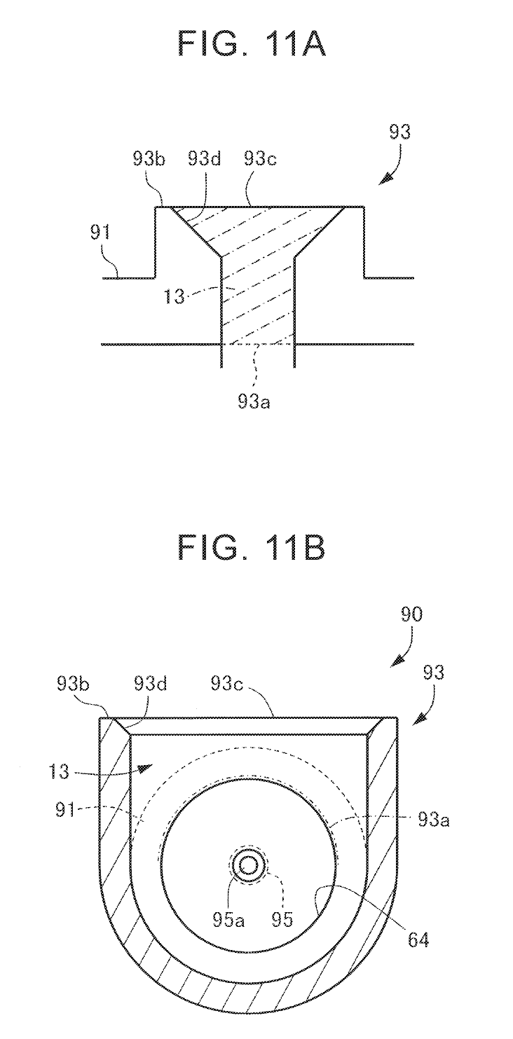

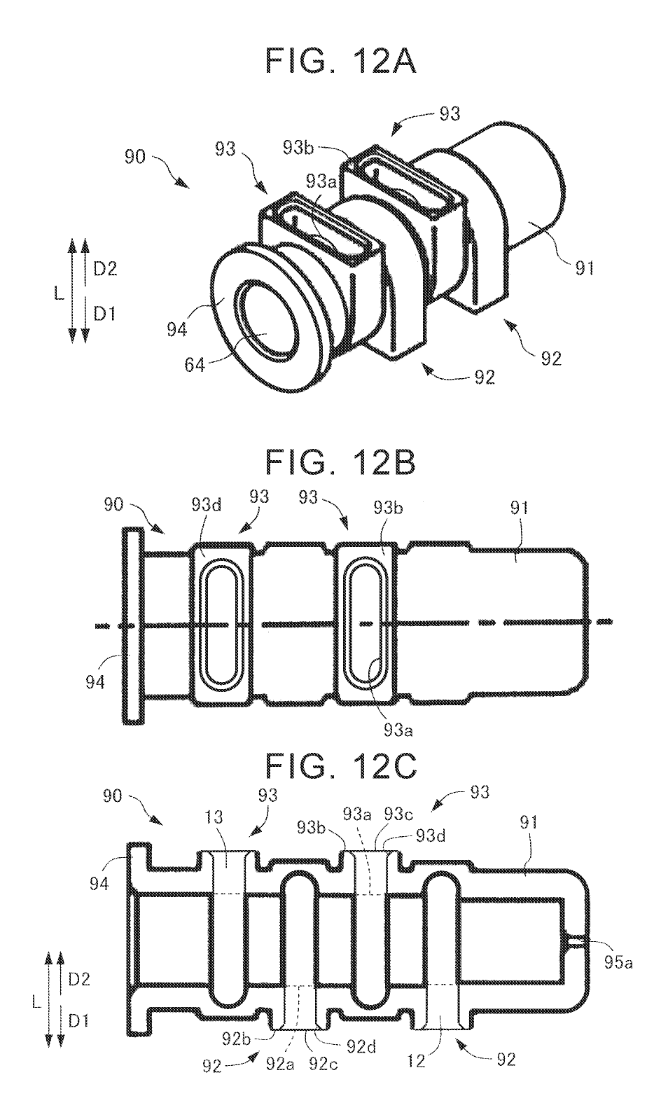

The port portions 93 have: the plurality of second ports 93a which are formed in a wall surface of the hole portion 64 of the sleeve main body 91 and which are configured to vary the state of communication between the inside and the outside of the sleeve main body 91 in accordance with the position of the spool 68p; communication holes 13 that allow communication between the outside surface of the sleeve main body 91 and the second ports 93a; and opening portions 93c at which the communication holes 13 open in the outside surface of the sleeve main body 91. The second ports 93a are curved surface portions provided in a wall surface of the hole portion 64, that is, the inner peripheral surface of the sleeve main body 91, to open in the hole portion 64 (see the broken line in FIG. 11A and the dash-and-dot line in FIG. 11B). In the present embodiment, the second ports 93a are each in an oval shape as viewed from the opening portion 93c side. Therefore, leakage of a synthetic resin material from angled portions during injection molding can be suppressed easily compared to a case where the second ports 93a are each in a rectangular shape. Moreover, the length of each second port 93a in the longitudinal direction can be made equivalent to the width of the sleeve main body 91, so that the second port 93a having a large sectional area can be formed. Consequently, the flow rate through each of the second ports 93a can be increased. The communication holes 13 are formed such that their center lines intersects the center line of the hole portion 64. Here, the communication holes 13 are formed such that their center lines are orthogonal to the center line of the hole portion 64. The opening portions 93c are orthogonal to the center lines of the communication holes 13. Therefore, the center line of the hole portion 64 and the opening portions 93c are provided in parallel with each other. In addition, the opening portions 93c are formed so as to project from the outside surface of the sleeve main body 91 toward the radially outer side. The opening portions 93c are disposed on the same plane as each other.

In addition, the port portions 93 each have a planar portion (first connection surface) 93b and a tapered portion (second connection surface) 93d as connection surfaces. The planar portion 93b and the tapered portion 93d are formed continuously with the opening portion 93c to have a band-shaped width so as to include a line that circulates on a plane that intersects the center line of the communication hole 13, and are connectable to the oil passage 72. The phrase “connectable to the oil passage 72” is used to cover a case where the planar portion 93b and the tapered portion 93d are not connected to the oil passage 72.

The planar portion 93b is provided around each of the plurality of second ports 93a, provided with the opening portion 93c of the second port 93a, and formed in a planar shape. That is, the planar portion 93b is a flat surface disposed at the outer periphery of the opening portion 93c. The planar portion 93b is continuous with the opening portion 93c adjacently on the outer peripheral side, and is formed in the shape of a flat surface having a band-shaped width in an oval shape on a plane that is orthogonal to the center line of the communication hole 13. In the present embodiment, the planar portions 93b corresponding to the second ports 93a each have one opening portion 93c.

The tapered portion 93d is a tapered surface formed to define the communication hole 13 and graded with the port 93a side narrower than the opening portion 93c side, and is a tapered surface that becomes narrower from the opening portion 93c at the planar portion 93b toward the inside of the sleeve main body 91. The tapered portion 93d is continuous with the opening portion 93c adjacently on the inner peripheral side, and is formed in the shape of a curved surface having a band-shaped width in an oval shape and intersecting a plane that is orthogonal to the center line of the communication hole 13. Here, the tapered portion 93d is directly continuous with the opening portion 93c. However, the tapered portion 93d is not limited thereto. For example, the tapered portion may be provided at a position of the communication hole 13 on the port 93a side with respect to the opening portion 93c. Similarly to the port portion 93, the port portions 92 have the plurality of first ports 92a, communication holes 12 that allow communication between the outside surface of the sleeve main body 91 and the first ports 92a, opening portions 92c at which the communication holes 12 open in the outside surface of the sleeve main body 91, planar portions 92b provided around the plurality of first ports 92a, and tapered portions 92d.

As illustrated in FIG. 5B, the oil passage 71 is connected to the tapered portions 92d and the oil passages 72 are connected to the tapered portions 93d. That is, the body portion 61b is made of a synthetic resin and formed around the sleeve 90, and includes the oil passages 71 and 72 which have opening end portions 61a that communicate with the plurality of ports 92a and 93a and that tightly contact the tapered portions 92d and 93d and the planar portions 92b and 93b of the plurality of ports 92a and 93a.

In addition, the ports 92a and 93a have at least two first ports 92a and at least one second port 93a. The at least two first ports 92a are disposed on the same side of the sleeve main body 91 in a first direction D1 that is orthogonal to the center line of the sleeve main body 91, and the planar portions 92b in which the opening portions 92c of the first ports 92a are formed are provided in parallel with each other. The at least one second port 93a is disposed on the opposite side (second direction D2) of the sleeve main body 91 from the first ports 92a in the first direction D1 which is orthogonal to the center line of the sleeve main body 91, and the planar portion 93b in which the opening portion 93c of the second port 93a is formed is provided in parallel with the planar portions 92b of the first ports 92a. In addition, the first ports 92a and the second port 93a are disposed alternately on the center line of the sleeve main body 91.

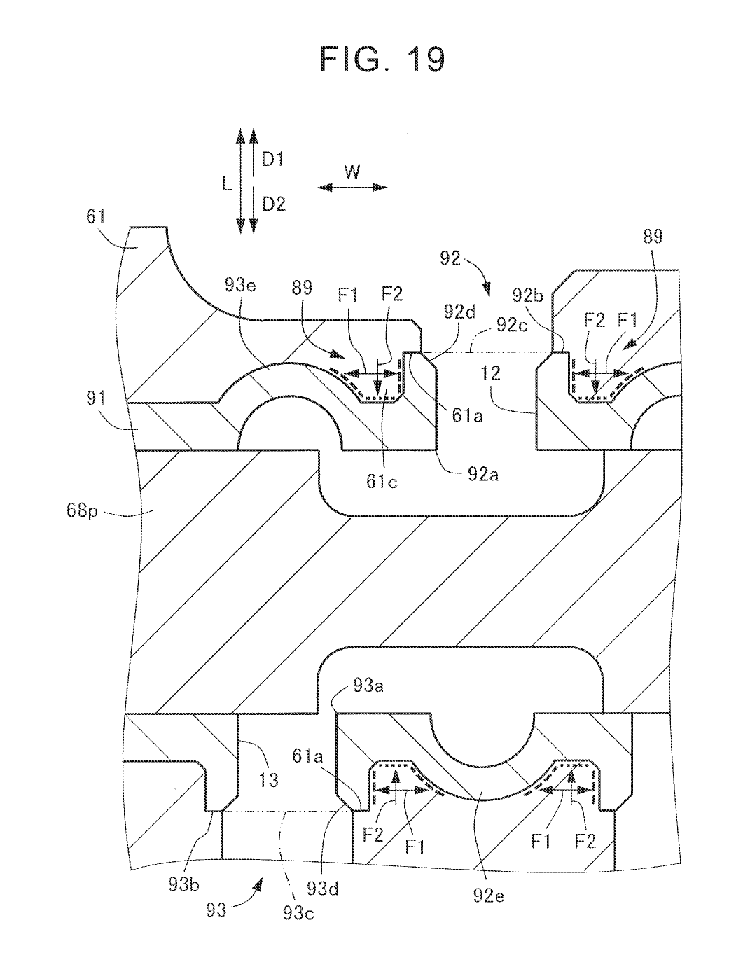

Here, as illustrated in FIG. 19, the sleeve 90 has a first port portion 92 that includes the first opening portion 92c (i.e., first opening), and a second port portion 93 that includes the second opening portion 93c (i.e., second opening) which is disposed at a position that is different from that of the first opening portion 92c in an axial direction W of the sleeve main body 91. The sleeve 90 also has a first projecting portion 92e (i.e., first projection), a second projecting portion 93e (i.e., second projection), and recessed portions 89 (i.e., recess). The first projecting portion 92e is provided so as to be continuous in the circumferential direction from the first opening portion 92c, and formed so as to project from the sleeve main body 91 toward the radially outer side over the entire periphery. The second projecting portion 93e is provided so as to be continuous in the circumferential direction from the second opening portion 93c, and formed so as to project from the sleeve main body 91 toward the radially outer side over the entire periphery. The recessed portions 89 are interposed between the first opening portion 92c and first projecting portion 92e and the second opening portion 93c and the second projecting portion 93e in the axial direction W, and formed so as to be recessed over the entire periphery. In addition, the body portion 61b has projecting portions 61c fitted with the recessed portions 89.

In the case where the sleeve 90 is used in a high-temperature environment, the amount of thermal expansion of the projecting portions 61c is larger than that of the recessed portions 89 because of the difference in coefficient of thermal expansion between the recessed portions 89 which are made of metal and the projecting portions 61c which are made of a synthetic resin. Therefore, the projecting portions 61c are expanded in the axial direction W to generate a pressing force F1 that presses portions that extend in a direction that intersects the axial direction W, that is, side surfaces (long broken lines in the drawing) of the recessed portions 89 in the axial direction W. Consequently, the seal performance is enhanced at the portions which are pressed in the axial direction W. In the case where the sleeve 90 is used in a low-temperature environment, on the other hand, the amount of thermal expansion of the projecting portions 61c is smaller than that of the recessed portions 89 because of the difference in coefficient of thermal expansion between the recessed portions 89 which are made of metal and the projecting portions 61c which are made of a synthetic resin. Therefore, the projecting portions 61c are contracted in the radial direction to generate a tightening force F2 that tightens portions that extend in a direction that intersects the radial direction, that is, bottom surfaces (short broken lines in the drawing) of the recessed portions 89, in the radial direction. Consequently, the seal performance is enhanced at the portions which are tightened in the radial direction.

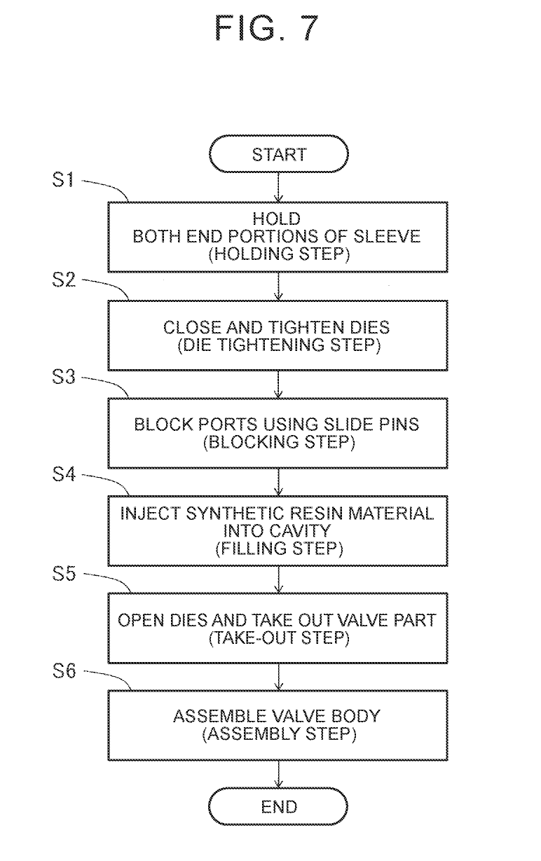

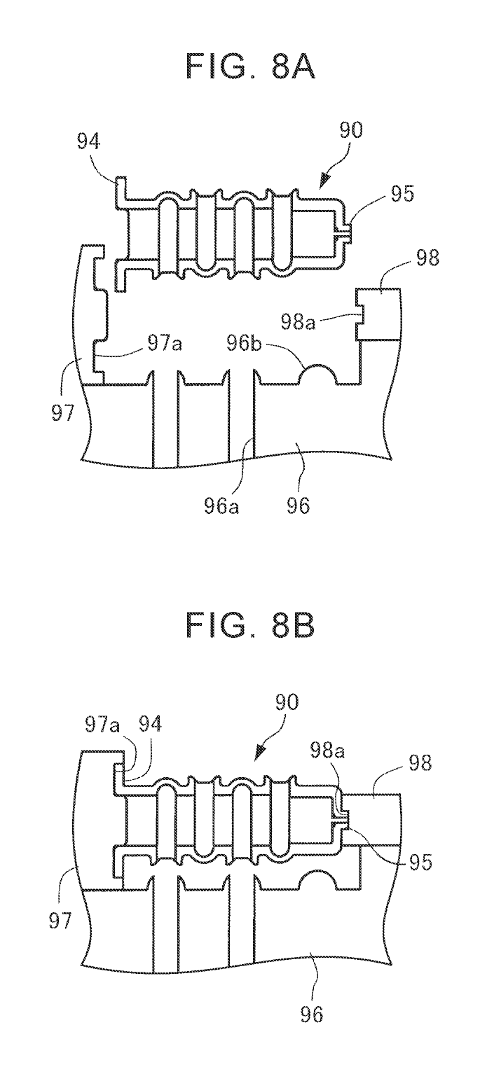

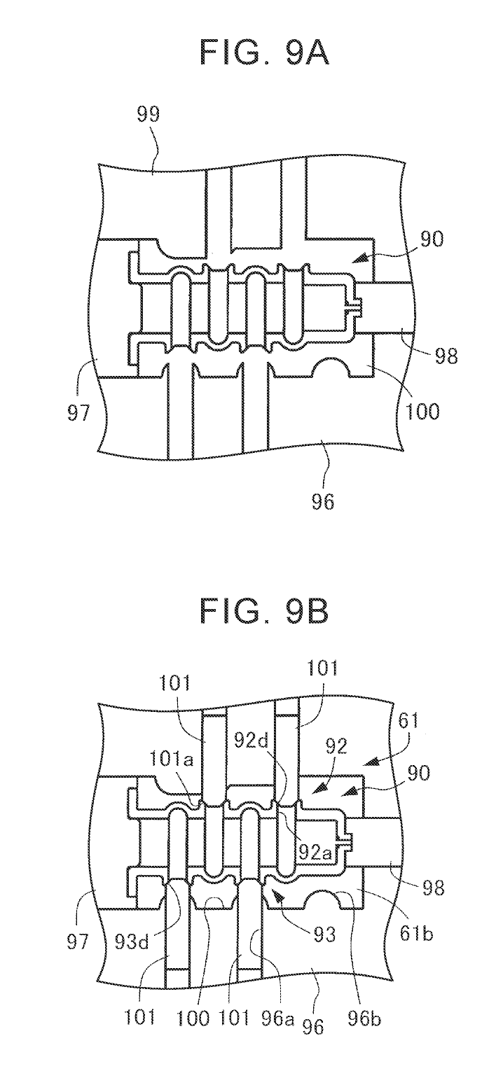

Next, the procedure of a method of manufacturing the valve part of the hydraulic control device 4 for the automatic transmission 3 discussed above will be described with reference to the flowchart illustrated in FIG. 7 while referring to FIGS. 8A to 9B. Here, the procedure of forming the fourth layer 61 by injection molding (insert molding) will be mainly described.

First, as illustrated in FIG. 8A, slide dies 97 and 98 that are slidable in directions to approach each other are placed on a die (mold) 96. The slide die 97 has a retention hole 97a that can retain the flange portion 94 of the sleeve 90 to tightly seal the sleeve 90. The slide die 98 has a retention hole 98a that can retain the projecting portion 95 of the sleeve 90 to tightly seal the sleeve 90. The die 96 is provided with a plurality of guide holes 96a in which slide pins 101 to be discussed later are slidable, and a protruding portion 96b that projects into a cavity.

As illustrated in FIG. 8B, the flange portion 94 is mounted to the retention hole 97a of the slide die 97, the projecting portion 95 is mounted to the retention hole 98a of the slide die 98, and the slide dies 97 and 98 are slid in directions to approach each other to hold the sleeve 90 at both end portions (step S1: holding step). In the present embodiment, the procedure includes the holding step. However, the procedure is not limited thereto, and the retention step may not necessarily be included. As illustrated in FIG. 9A, a die 99 that faces the die 96 is closed to tighten the molds (step S2: die tightening step). At this time, no gap is provided between the slide dies 97 and 98 and the dies 96 and 99. That is, the dies 96 and 99 are tightened so as to form a cavity 100 to be filled with a molding material at the outer peripheral portion (i.e., outer periphery) of the sleeve 90.

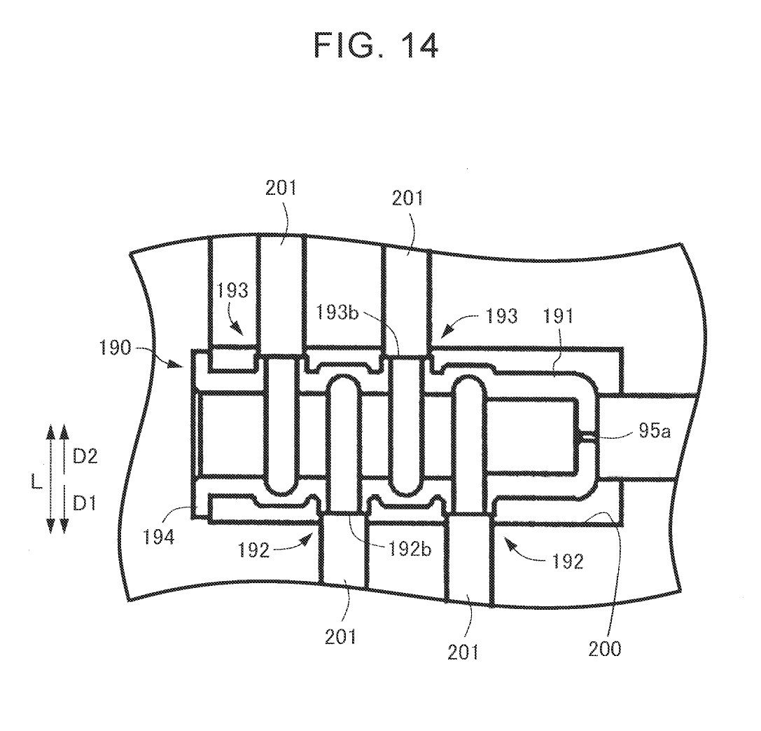

Further, as illustrated in FIG. 9B, the slide pins (pin members) 101 are inserted from the guide holes 96a to block the ports 92a and 93a of the port portions 92 and 93 (step S3: blocking step). Tapered portions 101a are formed at the distal end portions of the slide pins 101. Consequently, the tapered portions 101a of the slide pins 101 are pressed to tightly contact the tapered portions 92d and 93d of the port portions 92 and 93 to block the ports 92a and 93a, and then, the cavity 100 is filled by injecting a synthetic resin material (step S4: filling step). Here, the tapered portions 101a of the slide pins 101 are in tight contact with the tapered portions 92d and 93d of the port portions 92 and 93. Thus, leakage of the synthetic resin material (molding material) from the cavity 100 into the sleeve 90 can be suppressed compared to a case where the tapered portions 101a, 92b, and 93b are not provided. When the synthetic resin material is cooled, the body portion 61b is cured. In the present embodiment, the slide pins 101 in which the tapered portions 101a are formed at their distal end portions are applied. However, the slide pins 101 are not limited thereto. For example, slide pins with planar distal end portions may be utilized to bring the distal end portions of the slide pins into tight contact with the planar portions 92b and 93b of the port portions 92 and 93 (see FIG. 14). In this case as well, leakage of the synthetic resin material from the cavity 100 into the sleeve 90 can be suppressed compared to a case where the planar portions 92b and 93b are not provided.

Next, the dies 96 and 99 are opened and the clearance between the slide dies 97 and 98 is increased to take out the fourth layer 61 which serves as a valve part (step S5: take-out step). That is, the fourth layer 61 which has the body portion 61b which is molded from a molding material and the sleeve 90 is taken out from the dies 96 to 99. After that, the first layer 41 to the sixth layer 63 are stacked on each other to assemble the hydraulic control device 4 as a valve assembly by bonding, welding, etc. (step S6: assembly step). That is, the hydraulic control device 4 is assembled with at least the fourth layer 61 incorporated. In the present embodiment, the filling step is performed after the holding step, the die tightening step, and blocking step are executed in this order. However, the order of the holding step, the die tightening step, and the blocking step is not limited thereto.

Next, operation of the hydraulic control device 4 for the automatic transmission 3 discussed above will be described with reference to FIGS. 1 to 4.

When the oil pump is driven and a hydraulic pressure is supplied after the internal combustion engine 2 is started, a line pressure and a modulator pressure are generated by the regulator valve 80 and the modulator valve 81. The line pressure and the modulator pressure which have been generated flow through the oil passages 71 and 72 of the solenoid installation section 60 to be supplied to the linear solenoid valves 66 and the solenoid valves 67. The linear solenoid valves 66 operate in accordance with an electric signal from the ECU 5, and generate and output a desired hydraulic pressure on the basis of the line pressure and the modulator pressure. The solenoid valves 67 operate in accordance with an electric signal from the ECU 5, and turn on and off supply of a hydraulic pressure on the basis of the line pressure and the modulator pressure.

A part of the hydraulic pressure which is supplied from the linear solenoid valves 66 and the solenoid valves 67 is supplied from the third oil passages 71 to the automatic transmission 3 through the valve installation section 40. In addition, another part of the hydraulic pressure which is supplied from the linear solenoid valves 66 and the solenoid valves 67 is supplied from the third oil passages 71 to the switching valves 46 by way of the first oil passages 51 and through the fifth layer 62 (second layer 42). Consequently, a hydraulic pressure is supplied to the automatic transmission 3 by way of the second oil passages 52 and through the third layer 43 with the positions of the spools 46p of the switching valves 46 changed or with communication between the ports 45a, 45b, and 45c allowed or blocked. When a hydraulic pressure is supplied to the automatic transmission 3, the clutches, the brakes, etc. of the automatic transmission 3 are engaged and disengaged to establish a desired shift speed, or various portions of the automatic transmission 3 are lubricated.

With the hydraulic control device 4 for the automatic transmission 3 according to the present embodiment, as has been described above, the sleeve 90 is provided with the port portions 92 and 93 which project from the outside surface of the sleeve main body 91 toward the radially outer side. Thus, the port portions 92 and 93 function as ribs of the sleeve main body 91, and therefore the rigidity of the sleeve 90 can be enhanced. Therefore, the sleeve 90 is not easily deformed even upon receiving an injection pressure of an injection material when insert molding of the sleeve 90 in the body portion 61b etc. is performed, for example. Consequently, a valve part that utilizes the sleeve 90 with improved rigidity can be obtained without incurring an increase in size of the valve body.

In a valve that utilizes a spool according to the related art, a sleeve (spool housing) is made of metal, a body portion is made of a synthetic resin, and a flange portion is provided at the outer peripheral portion of the sleeve in order to prevent separation between the sleeve and the body portion due to the difference in coefficient of thermal expansion. In the valve according to the related art discussed above, however, a consideration is not given to securing the seal performance around ports in spite of the difference in coefficient of thermal expansion, although the flange portion is provided at the outer peripheral portion of the sleeve in order to prevent separation between the sleeve and the body portion due to the difference in coefficient of thermal expansion. When a boundary surface between the sleeve and the body portion is exposed around the ports, and the body portion may be expanded to project from the boundary surface at high temperatures, or may be contracted to be depressed from the boundary surface at low temperatures. Consequently, separation may be caused between the sleeve and the body portion around the ports because of the difference in coefficient of thermal expansion, and the seal performance around the ports may not be secured. Thus, there has been desired a valve part in which a reduction in seal performance around ports due to thermal expansion can be suppressed in the case where insert molding is performed for a spool housing and a body portion with different coefficients of thermal expansion.

In the hydraulic control device 4 for the automatic transmission 3 according to the present embodiment, in contrast, the sleeve 90 has the recessed portions 89, and the projecting portions 61c of the body portion 61b are fitted with the recessed portions 89. Therefore, in the case where the sleeve 90 is used in a high-temperature environment, the amount of thermal expansion of the projecting portions 61c is larger than that of the recessed portions 89, and the projecting portions 61c generate the pressing force F1 which presses the side surfaces (long broken lines in FIG. 19) of the recessed portions 89 in the axial direction W. In the case where the sleeve 90 is used in a low-temperature environment, on the other hand, the amount of thermal expansion of the projecting portions 61c is smaller than that of the recessed portions 89, and the projecting portions 61c generate the tightening force F2 which tightens the bottom surfaces (short broken lines in FIG. 19) of the recessed portions 89 in the radial direction. Consequently, a reduction in seal performance around the ports 92a and 93a due to thermal expansion can be suppressed in the case where insert molding is performed for the sleeve 90 and the body portion 61b with different coefficients of thermal expansion.

The valve according to the related art has a spool housing that slidably houses a spool. The sleeve, which is an example of the spool housing, includes a sleeve main body in a cylindrical shape, and port portions that include a plurality of through holes formed in a peripheral side surface of the sleeve main body. The port portions are formed in the peripheral side surface of the sleeve main body with their longitudinal direction corresponding to the circumferential direction. Therefore, edge portions, namely, opening portions, of the port portions on the radially outer side in the radial direction of the sleeve main body are formed on curved surfaces. In addition, the body portion, which is made of a synthetic resin, of the valve body is provided with the oil passages which communicate with the port portions. When forming such a valve body by injection molding, the port portions of the sleeve are blocked by the pin members before or after the sleeve is tightened by the dies in order to form oil passages that communicate with the port portions of the sleeve. Leakage of a synthetic resin material from the port portions into the sleeve can be prevented with the port portions blocked by the pin members.

With this manufacturing method, however, the opening portions of the port portions of the sleeve are formed on a curved surface, and thus a minute gap may be formed between the port portions and the pin members because of a dimensional error or the like even if the pin members are pressed against the port portions during injection molding. Therefore, a synthetic resin material may leak into the sleeve to remain as a foreign matter, and the foreign matter may cause the spool of the valve after completion to stick. Thus, there have been desired a valve part in which leakage of a synthetic resin material from port portions into a spool housing can be suppressed during injection molding, and a method of manufacturing the valve part.

In the hydraulic control device 4 for the automatic transmission 3 according to the present embodiment, in contrast, the tapered portions 92d and 93d are formed so as to be continuous with the opening portions 92c and 93c of the ports 92a and 93a of the sleeve 90. Thus, formation of a gap between the slide pins 101 and the opening portions 92c and 93c of the ports 92a and 93a can be significantly suppressed, compared to a case where the opening portions 92c and 93c of the ports 92a and 93a are formed on a curved surface, when the opening portions 92c and 93c of the ports 92a and 93a are blocked by the slide pins 101 during injection molding. Therefore, leakage of a molding material from the ports 92a and 93a into the sleeve 90 during injection molding can be suppressed, and the spool 68a of the linear solenoid valve 66 after completion can be prevented from sticking because of a foreign matter that is the molding material which has leaked into and remains inside the sleeve 90.

In the hydraulic control device 4 for the automatic transmission 3 according to the present embodiment, in addition, the port portions 92 and 93 have the tapered portions 92d and 93d. Thus, the sealing performance against the slide pins 101 which are pressed can be further enhanced. Therefore, leakage of a synthetic resin material from the cavity 100 into the sleeve 90 can be suppressed.

In the hydraulic control device 4 for the automatic transmission 3 according to the present embodiment, in addition, the port portions 92 and 93 have the tapered portions 92d and 93d and the planar portions 92b and 93b as connection surfaces. Therefore, the slide pins 101 can be brought into tight contact with either the tapered portions 92d and 93d or the planar portions 92b and 93b when the ports 92a and 93a are blocked by the slide pins 101 in the blocking step during manufacture. Therefore, the diameters of the oil passages 71 and 72 can be changed, and thus the sleeve 90 can be used commonly for hydraulic control devices 4 in which the oil passages 71 and 72 have different diameters.

In the hydraulic control device 4 for the automatic transmission 3 according to the present embodiment, in addition, in the solenoid installation section 60, the third oil passages 71 and the fourth oil passages 72 are disposed in a staggered manner one by one across the linear solenoid valves 66 or the solenoid valves 67 in the stacking direction L. Therefore, the oil passages 71 and 72 which communicate with the adjacent ports 92a and 93a, respectively, are not disposed adjacent to each other. Thus, it is not necessary to increase the pitch of the ports 92a and 93a, and an increase in overall length of the linear solenoid valves 66 and the solenoid valves 67 can be suppressed. Consequently, an increase in size of the valve body can be suppressed even if the valve body is formed by stacking blocks made of a synthetic resin etc. on each other. Similarly in the valve installation section 40, as in the solenoid installation section 60, the first oil passages 51 and the second oil passages 52 are disposed in a staggered manner one by one across the switching valves 46 in the stacking direction L, so that the same effect is achieved.

In the hydraulic control device 4 for the automatic transmission 3 according to the present embodiment discussed above, all the first layer 41 to the sixth layer 63 are made of a synthetic resin. However, the material of the layers is not limited thereto, and at least some of the layers may be made of metal such as die-cast aluminum, for example. In the hydraulic control device 4 for the automatic transmission 3 according to the present embodiment, in addition, the plurality of first ports 92a are configured such that the planar portions 92b in which the opening portions 92c of the first ports 92a are formed are provided in parallel with and separately from each other in the first direction D1 which is orthogonal to the center line of the sleeve main body 91. However, the planer portions 92b are not limited thereto, and the planar portions may be on an identical continuous flat surface. The same also applies to the planar portions 93b in which the opening portions 93c of the plurality of second ports 93a are formed.

In the hydraulic control device 4 for the automatic transmission 3 according to the present embodiment, in addition, the port portions 92 and 93 have the tapered portions 92d and 93d and the planar portions 92b and 93b as connection surfaces. However, the port portions 92 and 93 are not limited thereto, and the port portions 92 and 93 may have either the tapered portions 92d and 93d or the planar portions 92b and 93b. Even when the port portions 92 and 93 have either the tapered portions 92d and 93d or the planar portions 92b and 93b, leakage of a molding material from the ports 92a and 93a into the sleeve 90 during injection molding can be suppressed.

In the hydraulic control device 4 for the automatic transmission 3 according to the present embodiment, in addition, the description is given of the sleeve 90 of the linear solenoid valve 66. However, the present disclosure is not limited thereto, and is generally applicable to spool housings of valves that have a slidable spool, such as the solenoid valves 67 and the switching valves 46.

In the hydraulic control device 4 for the automatic transmission 3 according to the present embodiment, in addition, the port portions 92 and 93 of the sleeve 90 are formed to have a curved outer peripheral surface in a generally annular shape. However, the shape of the port portions 92, and 93 is not limited thereto, and the port portions 92 and 93 may be formed to have a planar outer peripheral surface in a generally circular column shape.

### Second Embodiment

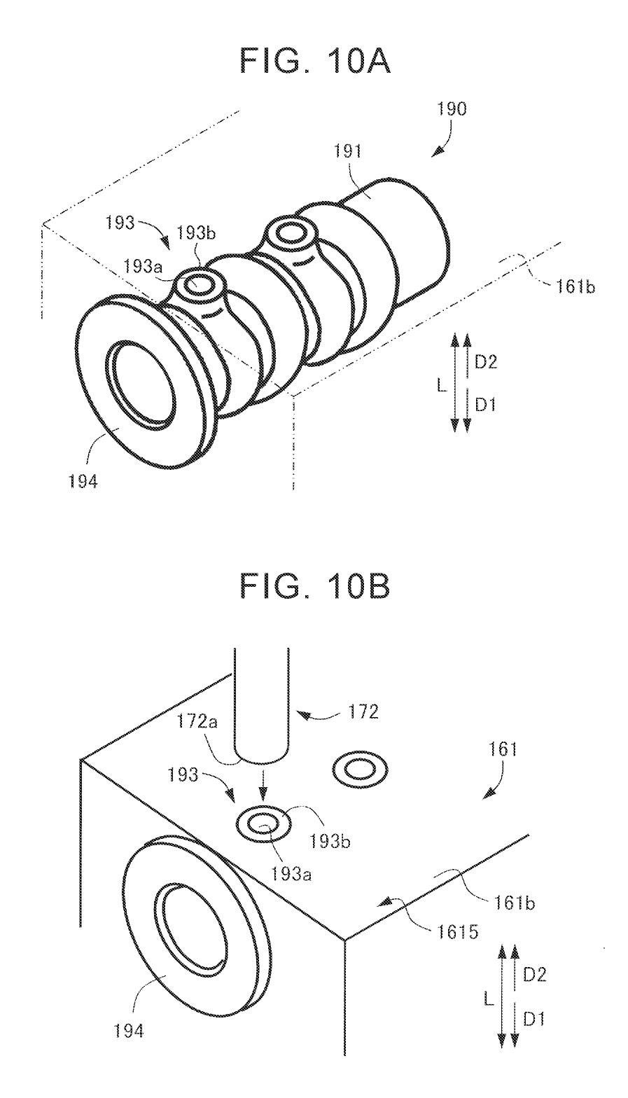

Next, a second embodiment will be described in detail with reference to FIGS. 10A and 10B. A sleeve 190 according to the present embodiment is different in configuration from the sleeve according to the first embodiment in that port portions 193 each have a planar portion 193b as a connection surface and do not have a tapered portion. However, the other components have the same configuration as those according to the first embodiment, and thus the same reference numerals are given to omit detailed description.

In the present embodiment, as illustrated in FIG. 10A, the sleeve 190 has a sleeve main body 191, a flange portion 194, and the port portions 193, and the port portions 193 each have a port 193a in a perfect circle shape and the planar portion (connection surface) 193b which is formed around the port 193a. The port 193a is in a perfect circle shape as viewed from the opening portion 193c side. In a fourth layer 161 that has the sleeve 190 and a body portion 161b, as illustrated in FIG. 10B, the planar portion 193b is exposed to a fifth surface 1615. An oil pipe (oil passage) 172 that has a perfect circle cross-sectional shape and an opening end portion 172a configured to tightly contact the planar portion 193b can be mounted to the planar portion 193b to form the hydraulic control device 4.

In the present embodiment as well, the sleeve 190 is provided with the port portions 193 which project from the outside surface of the sleeve main body 191 toward the radially outer side. Thus, the port portions 193 function as ribs of the sleeve main body 191, and therefore the rigidity of the sleeve 190 can be enhanced. Therefore, the sleeve 190 is not easily deformed even upon receiving an injection pressure of an injection material when insert molding of the sleeve 190 in the body portion 161b etc. is performed, for example. Consequently, a valve part that utilizes the sleeve 190 with improved rigidity can be obtained without incurring an increase in size of the valve body. In addition, the sleeve 190 has recessed portions. Thus, a reduction in seal performance around the ports 193a due to thermal expansion can be suppressed in the case where insert molding is performed for the sleeve 190 and the body portion 161b that have different coefficients of thermal expansion. In addition, formation of a gap between the slide pins and the opening portions 193c of the ports 193a can be significantly suppressed. Thus, leakage of a molding material from the ports 193a into the sleeve 190 during injection molding can be suppressed. In addition, the ports 193a are each in a perfect circle shape. Thus, oil pipes with a perfect circle cross-sectional shape can be directly mounted to the ports 193a, so that the assemblability is enhanced.

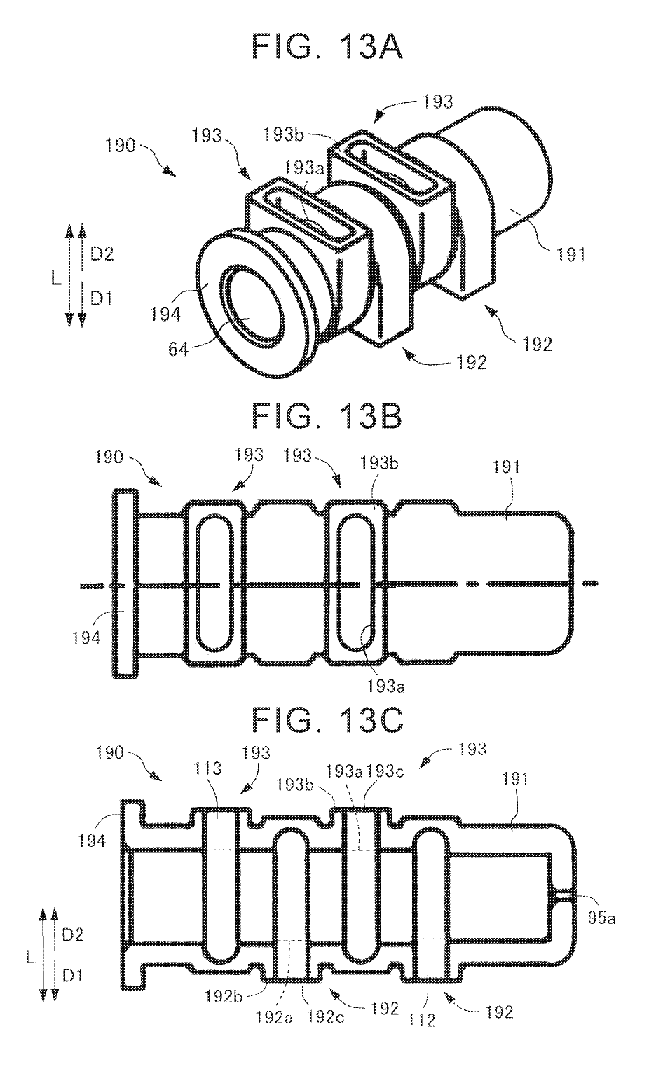

In the sleeve 190 according to the second embodiment discussed above, the ports 193a are each in a perfect circle shape as viewed from the opening portion 193c side. However, the shape of the ports 193a is not limited thereto. For example, as illustrated in FIGS. 13A, 13B, and 13C, the ports 193a may each be in an oval shape as viewed from the opening portion 193c side. In this case, the port portions 192 and 193 have the plurality of ports 192a and 193a, communication holes 112 and 113 that allow communication between the outside surface of the sleeve main body 191 and the ports 192a and 193a, the opening portions 192c and 193c at which the communication holes 112 and 113 open in the outside surface of the sleeve main body 191, and the planar portions (connection surfaces) 192b and 193b. In this case, the length of each of the ports 192a and 193a in the longitudinal direction can be made equivalent to the width of the sleeve main body 191, so that the ports 192a and 193a having a large sectional area can be formed. Consequently, the flow rate through each of the ports 192a and 193a can be increased.

In this case, in addition, in the blocking step during manufacture, as illustrated in FIG. 14, slide pins (pin members) 201 are inserted from guide holes to block the ports 192a and 193a of the port portions 192 and 193. The distal end portions of the slide pins 101 are planar, and the distal end portions of the slide pins 201 are brought into tight contact with the planar portions 192b and 193b of the port portions 192 and 193 to block the ports 92a and 93a. In this case, leakage of the synthetic resin material from a cavity 200 into the sleeve 190 can be suppressed by the tight contact between the slide pins 201 and the planar portions 192b and 193b.

### Third Embodiment

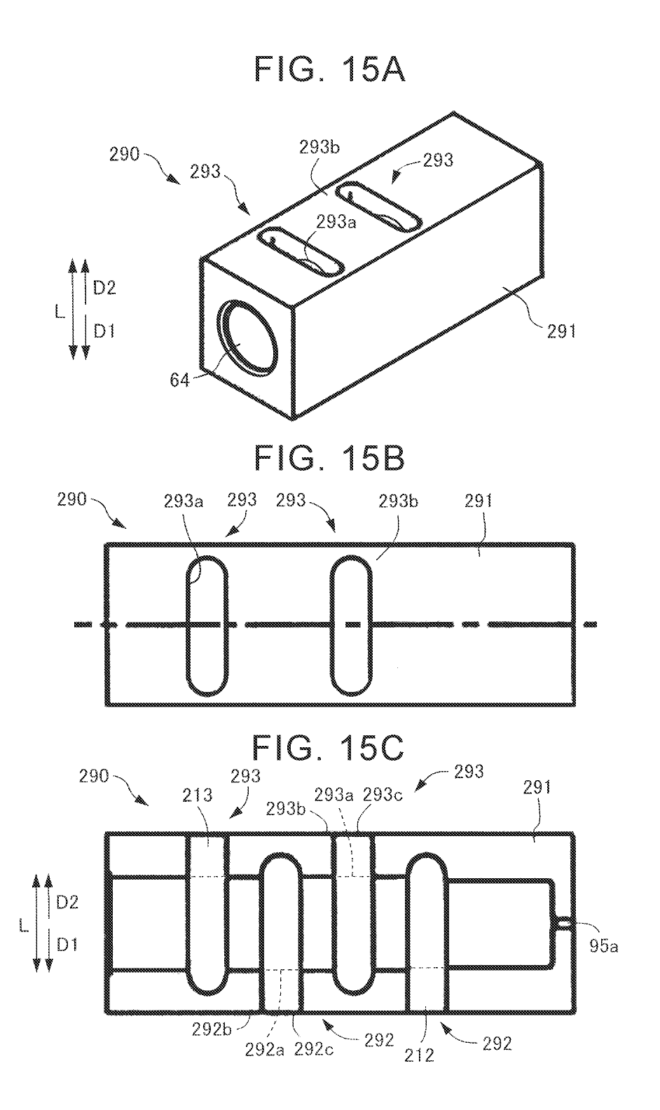

Next, a third embodiment will be described in detail with reference to FIGS. 15A, 15B, and 15C. A sleeve 290 according to the present embodiment is different in configuration from the sleeve according to the second embodiment in that a sleeve main body 291 is a block in a rectangular parallelepiped shape. However, the other components have the same configuration as those according to the second embodiment, and thus the same reference numerals are given to omit detailed description.

In the present embodiment, the sleeve 290 has a sleeve main body 291 and port portions 292 and 293. The port portions 292 and 293 have ports 292a and 293a in an oval shape, communication holes 212 and 213, opening portions 292c and 293c at which the communication holes 212 and 213 open in the outside surfaces of the sleeve main body 291, and planar portions (connection surfaces) 292b and 293b formed around the opening portions 292c and 293c. Here, the planar portions 292b and 293b are flush with the respective side surfaces of the sleeve main body 291.

In the present embodiment as well, formation of a gap between the slide pins and the opening portions 292c and 293c of the ports 292a and 293a can be significantly suppressed. Thus, leakage of a molding material from the ports 292a and 293a into the sleeve 290 during injection molding can be suppressed. In addition, the sleeve main body 291 is in a rectangular parallelepiped shape. Thus, the planarity of the planar portions 292b and 293b can be secured easily, and the degree of freedom in design can be improved.

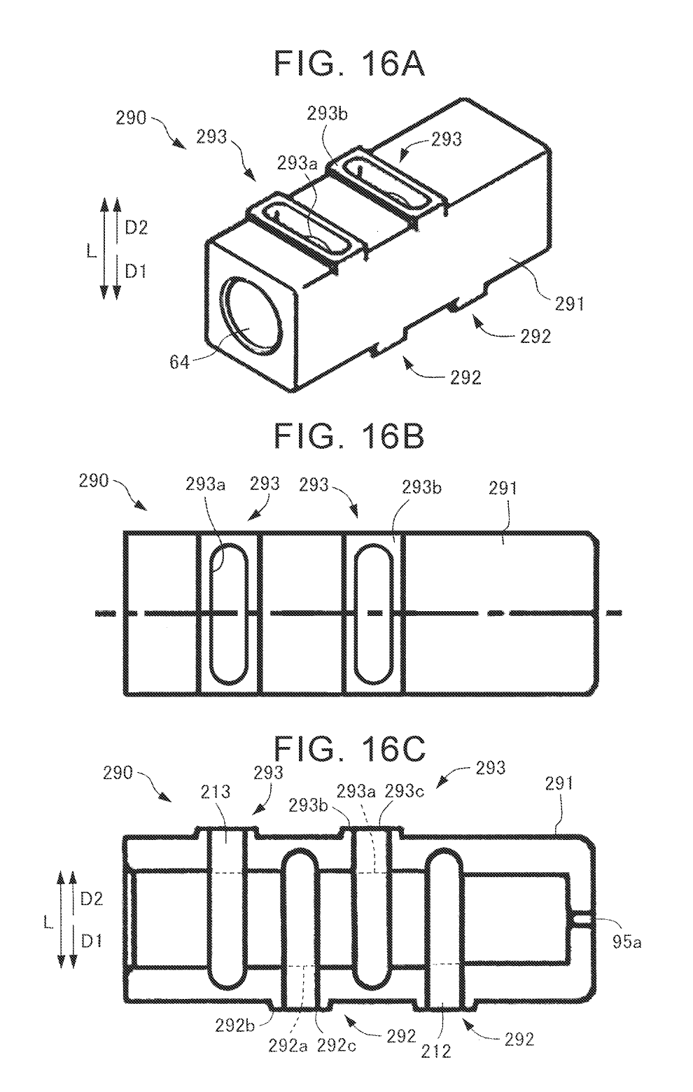

In the sleeve 290 according to the third embodiment discussed above, the planar portions 292b and 293b are flush with the respective side surfaces of the sleeve main body 291. However, the present disclosure is not limited thereto. For example, as illustrated in FIGS. 16A, 16B, and 16C, the opening portions 292c and 293c may be formed so as to project from the outside surfaces of the sleeve main body 291 toward the radially outer side. In this case, the opening portions 292c and the opening portions 293c are disposed so as to be flush with each other.

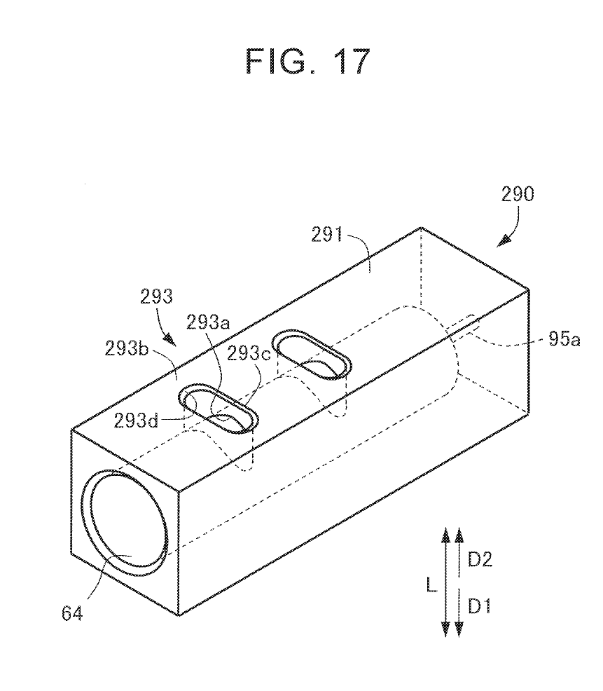

In the sleeve 290 according to the third embodiment discussed above, in addition, the port portions 292 and 293 each do not have a tapered portion. However, the present disclosure is not limited thereto. For example, as illustrated in FIG. 17, the port portions 293 may each have a tapered portion (connection surface) 293d. In this case, the port portions 293 each have the tapered portion 293d and the planar portion 293b as connection surfaces. Therefore, the slide pins 101 can be brought into tight contact with either the tapered portions 293d or the planar portions 293b when the ports 293a are blocked using the slide pins 101 in the blocking step during manufacture.

### Fourth Embodiment

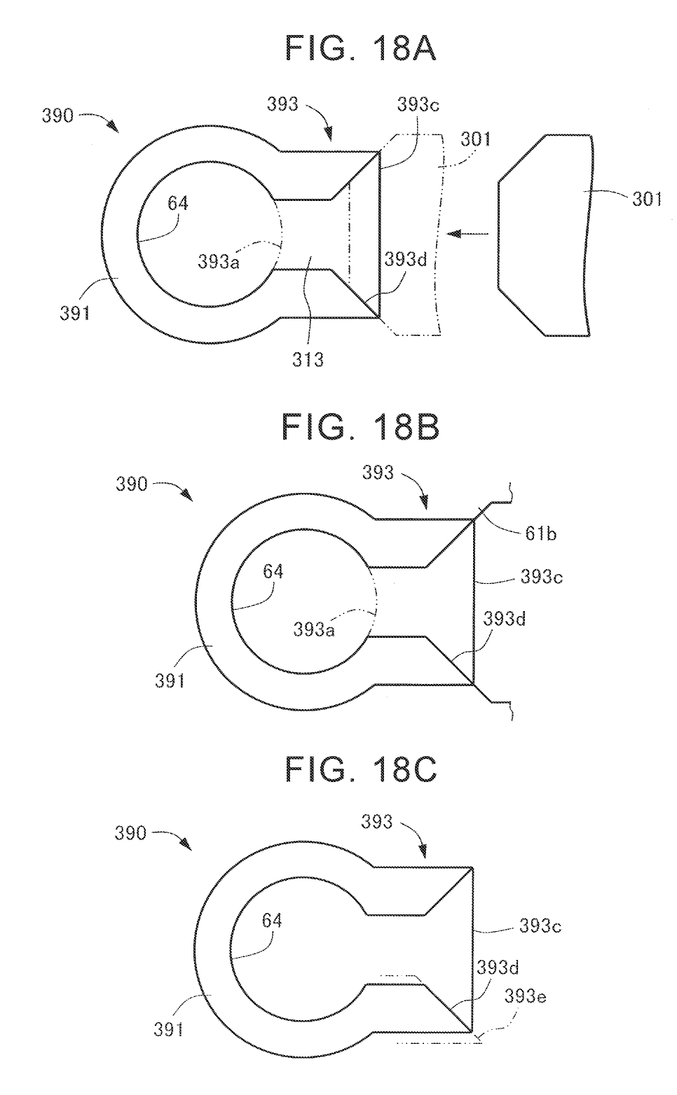

Next, a fourth embodiment will be described in detail with reference to FIGS. 18A and 18B. A sleeve 390 according to the present embodiment is different in configuration from the sleeve according to the first embodiment in that port portions 393 each have a tapered portion 393d as a connection surface and do not have a planar portion. However, the other components have the same configuration as those according to the first embodiment, and thus the same reference numerals are given to omit detailed description.

In the present embodiment, the sleeve 390 has a sleeve main body 391 and a port portion 393. The port portion 393 has a port 393a, a communication hole 313, an opening portion 393c at which the communication hole 313 opens in the outside surface of the sleeve main body 391, and the tapered portion (connection surface) 393d. The tapered portion 393d is a tapered surface formed to define the communication hole 313 and graded with the port 393a side narrower than the opening portion 393c side. The tapered portion 393d is continuous with the opening portion 393c adjacently on the inner peripheral side, and is formed in the shape of a curved surface having a band-shaped uniform width and intersecting a plane that is orthogonal to the center line of the communication hole 313. Here, the tapered portion 393d is formed so as to have a band-shaped uniform width. However, the shape of the tapered portion 393d is not limited thereto. A tapered portion 393e may be provided such that the tapered portion 393e is shaped so as to project or be recessed toward the inner peripheral side or the outer peripheral side with respect to the tapered portion 393d which has a uniform width as illustrated in FIG. 18C.

In the present embodiment as well, the sleeve 390 is provided with the port portion 393 which projects from the outside surface of the sleeve main body 391 toward the radially outer side. Thus, the port portion 393 functions as a rib of the sleeve main body 391, and therefore the rigidity of the sleeve 390 can be enhanced. Therefore, the sleeve 390 is not easily deformed even upon receiving an injection pressure of an injection material when insert molding of the sleeve 390 in the body portion 61b etc. is performed, for example. Consequently, a valve part that utilizes the sleeve 390 with improved rigidity can be obtained without incurring an increase in size of the valve body. In addition, the sleeve 390 has recessed portions. Thus, a reduction in seal performance around the ports 393a due to thermal expansion can be suppressed in the case where insert molding is performed for the sleeve 390 and the body portion 61b with different coefficients of thermal expansion. In addition, formation of a gap between slide pins 301 and the opening portions 393c of the ports 393a can be significantly suppressed. Thus, leakage of a molding material from the ports 393a into the sleeve 390 during injection molding can be suppressed. In addition, no planar portion is provided. Thus, there is no need to secure the planarity of a planar portion, and the sleeve 390 can be manufactured easily.

The present embodiments include at least the following configuration. The present embodiments provide a valve part (61, 161) including: a body portion (61b, 161b) made of a synthetic resin; and a spool housing (90, 190, 390) provided separately from the body portion (61b, 161b) and embedded in the body portion, in which: the body portion (61b, 161b) is formed so as to surround the spool housing (90, 190, 390); and the spool housing (90, 190, 390) has a main body portion (91, 191, 391) that has a hole portion (64) that slidably houses a spool (68p), a port (92a, 192a) formed in a wall surface of the hole portion (64) of the main body portion (91, 191, 391) and configured to vary a state of communication between an inside and an outside of the main body portion (91, 191, 391) in accordance with a position of the spool (68p), a communication hole (12, 112) that extends from the port (92a, 192a) toward a radially outer side, a first projecting portion (92e) in which the communication hole (12, 112) is formed and which is formed so as to project from an outside surface of the main body portion (91, 191, 391) toward the radially outer side, and a first opening portion (92c, 192c) at which the communication hole (12, 112) opens at a distal end portion of the first projecting portion (92e). According to this configuration, the spool housing (90, 190, 390) is provided with the opening portion which projects from the outside surface of the main body portion (91, 191, 391) toward the radially outer side. Thus, the opening portion functions as a rib of the main body portion (91, 191, 391), and therefore the rigidity of the spool housing (90, 190, 390) can be enhanced. Therefore, the spool housing (90, 190, 390) is not easily deformed even upon receiving an injection pressure of an injection material during insert molding of the spool housing (90, 190, 390), for example. Consequently, a valve part that utilizes the spool housing (90, 190, 390) with improved rigidity can be obtained without incurring an increase in size of the valve body.

In the valve part (61, 161) according to the present embodiments, in addition, a second opening portion (93c, 193c, 393c) is provided so as to be disposed at a different position from a position of the first opening portion (92c, 192c) in an axial direction (W) of the main body portion (91, 191, 391); the first projecting portion (92e) is provided so as to be continuous in a circumferential direction from the first opening portion (92c, 192c), and formed so as to project from the main body portion (91, 191, 391) toward the radially outer side over an entire periphery; and the spool housing (90, 190, 390) has a second projecting portion (93e) provided so as to be continuous in the circumferential direction from the second opening portion (93c, 193c, 393c), and formed so as to project from the main body portion (91, 191, 391) toward the radially outer side over the entire periphery, and a recessed portion (89) interposed between the first projecting portion (92e) and the second projecting portion (93e) in the axial direction (W) and formed so as to be recessed over the entire periphery. According to this configuration, the spool housing (90, 190, 390) has the recessed portion (89), and the projecting portion of the body portion (61b, 161b) is fitted with the recessed portion. Therefore, in the case where the spool housing (90, 190, 390) is used in a high-temperature environment, the amount of thermal expansion of the projecting portion is larger than that of the recessed portion (89), and the projecting portion generates a pressing force (F1) which presses the side surfaces of the recessed portion (89) in the axial direction W. In the case where the spool housing (90, 190, 390) is used in a low-temperature environment, on the other hand, the amount of thermal expansion of the projecting portion is smaller than that of the recessed portion (89), and the projecting portion generates a tightening force (F2) which tightens the bottom surface of the recessed portion (89) in the radial direction. Consequently, a reduction in seal performance around the ports due to thermal expansion can be suppressed in the case where insert molding is performed for the spool housing (90, 190, 390) and the body portion (61b, 161b) with different coefficients of thermal expansion.

In addition, the opening portion of each port is utilized as the projecting portion and the recessed portion for securing sealing performance. Thus, it is not necessary to provide the spool housing with another feature for securing the seal performance such as a flange portion, and the spool housing can be made compact in the radial direction.

In the valve part (61, 161) according to the present embodiments, in addition, the body portion (61b, 161b) has an oil passage that communicates with the port; and the spool housing (90, 190, 390) has a connection surface which is formed continuously with the first opening portion (92c, 192c) to have a band-shaped width so as to include a line that circulates on a plane that intersects a center line of the communication hole (12, 112), and to which the oil passage of the body portion (61b, 161b) is connected. According to this configuration, the connection surface is farmed so as to be continuous with the opening portion of the port of the spool housing (90, 190, 290, 390). Thus, formation of a gap between a pin member (101, 201, 301) and the opening portion of the port can be significantly suppressed, compared to a case where the opening portion of the port is formed on a curved surface, when the opening portion of the port is blocked by the pin member (101, 201, 301) during injection molding. Therefore, leakage of a molding material from the port into the spool housing (90, 190, 290, 390) during injection molding can be suppressed, and the spool (68p) of the valve after completion can be prevented from sticking because of a foreign matter that is the molding material which has leaked into and remains inside the spool housing (90, 190, 290, 390).

The present embodiments also provide a valve part (61, 161) including: a spool housing (90, 190, 290, 390) that has a main body portion (91, 191, 291, 391) made of metal and having a hole portion (64) that slidably houses a spool (68p), a port (92a, 93a, 192a, 193a, 292a, 293a, 393a) formed in a wall surface of the hole portion (64) of the main body portion (91, 191, 291, 391) and configured to vary a state of communication between an inside and an outside of the main body portion (91, 191, 291, 391) in accordance with a position of the spool (68p), a communication hole (12, 13, 112, 113, 212, 213, 313) that allows communication between an outside surface of the main body portion (91, 191, 291, 391) and the port, and an opening portion (92c, 93c, 192c, 193c, 292c, 293c, 393c) at which the communication hole opens in the outside surface of the main body portion (91, 191, 291, 391); and a body portion (61b, 161b) made of a synthetic resin, formed around the spool housing (90, 190, 290, 390), and having an oil passage (71, 72, 172) that communicates with the port. In the valve part (61, 161), the spool housing (90, 190, 290, 390) has a connection surface (92b, 92d, 93b, 93d, 192b, 193b, 292b, 293b, 293d, 393d) which is formed continuously with the opening portion to have a band-shaped width so as to include a line that circulates on a plane that intersects a center line of the communication hole, and to which the oil passage (71, 72, 172) of the body portion (61b, 161b) is connected. According to this configuration, the connection surface is formed so as to be continuous with the opening portion of the port of the spool housing (90, 190, 290, 390). Thus, formation of a gap between a pin member (101, 201, 301) and the opening portion of the port can be significantly suppressed, compared to a case where the opening portion of the port is formed on a curved surface, when the opening portion of the port is blocked by the pin member (101, 201, 301) during injection molding. Therefore, leakage of a molding material from the port into the spool housing (90, 190, 290, 390) during injection molding can be suppressed, and the spool (68p) of the valve after completion can be prevented from sticking because of a foreign matter that is the molding material which has leaked into and remains inside the spool housing (90, 190, 290, 390).

In the valve part (61, 161) according to the present embodiments, in addition, the connection surface (92b, 93b, 192b, 193b, 292b, 293b) is a flat surface disposed at an outer periphery of the opening portion (92c, 93c, 192c, 193c, 292c, 293c). According to this configuration, the connection surface can be formed easily.

In the valve part (61, 161) according to the present embodiments, in addition, a plurality of the ports (92a, 93a, 192a, 193a, 292a, 293a) are provided, and each of flat surfaces corresponding to the ports has one opening portion (92c, 93c, 192c, 193c, 292c, 293c). According to this configuration, the pin member (101, 201) and the port can be aligned with each other easily compared to a case where a plurality of ports are disposed on one planar portion, and leakage of a molding material from the port into the spool housing (90, 190, 290) during injection molding can be suppressed more reliably.

In the valve part (61, 161) according to the present embodiments, in addition, the connection surface (92d, 93d, 293d, 393d) is a tapered surface formed to define the communication hole (12, 13, 213, 313) and graded with a port (92a, 93a, 293a, 393a) side of the connection surface (92d, 93d, 293d, 393d) narrower than an opening portion (92c, 93c, 293c, 393c) side of the connection surface (92d, 93d, 293d, 393d). According to this configuration, the tight contact between the pin member (301) and the connection surface can be further enhanced, and leakage of a molding material from the ports into the spool housing (90, 290, 390) during injection molding can be suppressed more reliably.

In the valve part (61, 161) according to the present embodiments, in addition, the connection surface (92b, 92d, 93b, 93d, 192b, 193b, 292b, 293b, 293d, 393d) has a first connection surface (92b, 93b, 192b, 193b, 292b, 293b) and a second connection surface (92d, 93d, 293d, 393d); the first connection surface is a flat surface disposed at an outer periphery of the opening portion (92c, 93c, 192c, 193c, 292c, 293c, 393c); and the second connection surface is a tapered surface formed to define the communication hole (12, 13, 112, 113, 212, 213, 313) and graded with a port (92a, 93a, 192a, 193a, 292a, 293a, 393a) side of the second connection surface narrower than an opening portion side of the second connection surface. According to this configuration, the pin member (101, 201, 301) can be brought into tight contact with one of the first connection surface and the second connection surface when the port is blocked using the pin member (101, 201, 301) during injection molding. Therefore, the diameters of the oil passages (71, 72) can be changed, and thus the spool housing (90, 190, 290, 390) can be used commonly for hydraulic control devices in which the oil passages (71, 72) have different diameters.

In the valve part (61, 161) according to the present embodiments, in addition, an outer periphery of the opening portion (92c, 93c, 192c, 193c, 292c, 293c, 393c) is formed in a planar shape; and a center line of the communication hole (12, 13, 112, 113, 212, 213, 313) and the opening portion (92c, 93c, 192c, 193c, 292c, 293c, 393c) are orthogonal to each other. According to this configuration, the tight contact between the pin member (101, 201, 301) and the connection surface (92b, 92d, 93b, 93d, 192b, 193b, 292b, 293b, 293d, 393d) can be further enhanced, and leakage of a molding material from the port into the spool housing (90, 190, 290, 390) during injection molding can be suppressed more reliably.

In the valve part (61, 161) according to the present embodiments, in addition, the opening portion (92c, 93c, 192c, 193c, 292c, 293c, 393c) is formed so as to project from the outside surface of the main body portion (91, 191, 291, 391) toward the radially outer side. According to this configuration, processing in which a plurality of the opening portions are formed in parallel planes can be performed easily, so that the parallelism of the opening portions is enhanced.

In the valve part (61, 161) according to the present embodiments, in addition, the body portion (61b, 161b) includes an oil passage (71, 72) that communicates with each port (92a, 93a, 192a, 193a, 292a, 293a, 393a) and that has an opening end portion that tightly contacts the connection surface (92b, 92d, 93b, 93d, 192b, 193b, 292b, 293b, 293d, 393d). According to this configuration, the connection surface and the opening end portion tightly contact each other. Thus, oil leakage from a gap between the port and the oil passage (71, 72) can be suppressed.

In the valve part (61, 161) according to the present embodiments, in addition, the main body portion (91, 191, 391) is in a tubular shape. According to this configuration, the main body portion (91, 191, 391) can be manufactured easily.

In the valve part (61, 161) according to the present embodiments, in addition, the main body portion (291) is in a rectangular parallelepiped shape. According to this configuration, the planarity of the connection surface (292b, 293b, 293d) can be secured easily, and the degree of freedom in design can be improved.

In the valve part (61, 161) according to the present embodiments, in addition, the port (92a, 93a, 192a, 193a, 292a, 293a) is in an oval shape as viewed from an opening portion (92c, 93c, 192c, 193c, 292c, 293c) side. According to this configuration, leakage of a molding material from angled portions can be suppressed easily compared to a case where the port is in a rectangular shape. Moreover, the width of the port can be made equivalent to the width of the main body portion (91, 191, 291), so that the port having a large sectional area can be formed. Consequently, the flow rate through the port can be increased.

In the valve part (61, 161) according to the present embodiments, in addition, the port (192a, 193a, 393a) is in a perfect circle shape as viewed from an opening portion (192c, 193c, 393c) side. According to this configuration, an oil pipe with a perfect circle cross-sectional shape can be directly mounted to the port, so that the assemblability is enhanced.

In the valve part (61, 161) according to the present embodiments, in addition, the port (92a, 93a, 192a, 193a, 292a, 293a, 393a) has at least two first ports (92a, 192a, 292a); and the at least two first ports are disposed on the same side of the main body portion (91, 191, 291) in a first direction (D1) that is orthogonal to a center line of the main body portion (91, 191, 291), and the respective opening portions (92c, 192c, 292c) of the first ports are provided in parallel with each other. According to this configuration, according to this configuration, the pin members (101, 201) and the ports can be aligned with each other easily compared to a case where the planar portions are not parallel to each other, and leakage of a molding material from the ports into the spool housing (90, 190, 290) during injection molding can be suppressed more reliably.

In the valve part (61, 161) according to the present embodiments, in addition, the port (92a, 93a, 192a, 193a, 292a, 293a, 393a) has at least one second port (93a, 193a, 293a, 393a); and the at least one second port is disposed on the opposite side of the main body portion (91, 191, 291, 391) from the first ports in the first direction (D1) which is orthogonal to the center line of the main body portion (91, 191, 291, 391), and the opening portion (93c, 193c, 293c, 393c) of the second port is provided in parallel with the opening portions of the first ports. According to this configuration, the pin member (101, 201, 301) and the port can be aligned with each other easily compared to a case where the planar portion of the second port is not parallel to the planar portions of the first ports, and leakage of a molding material from the port into the spool housing (90, 190, 290, 390) during injection molding can be suppressed more reliably.

In the valve part (61, 161) according to the present embodiments, in addition, the first ports (92a, 192a, 292a) and the second port (93a, 193a, 293a, 393a) are disposed alternately on the center line of the main body portion (91, 191, 291, 391). According to this configuration, the oil passages (71, 72) which communicate with the adjacent ports are not disposed adjacent to each other. Thus, it is not necessary to increase the pitch of the ports, and an increase in overall length of the valve can be suppressed, so that an increase in size of the valve body is suppressed.

The present embodiments additionally provide a method of manufacturing a valve part (61, 161), including: a die tightening step of tightening a die so as to form a cavity to be filled with a molding material at an outer peripheral portion of a spool housing (90, 190, 290, 390) that has a main body portion (91, 191, 291, 391) that is made of metal and that has a hole portion (64) that slidably houses a spool (68p), a port (92a, 93a, 192a, 193a, 292a, 293a, 393a) formed in a wall surface of the hole portion (64) of the main body portion (91, 191, 291, 391) and configured to vary a state of communication between an inside and an outside of the main body portion (91, 191, 291, 391) in accordance with a position of the spool (68p), a communication hole (12, 13, 112, 113, 212, 213, 313) that allows communication between an outside surface of the main body portion (91, 191, 291, 391) and the port, an opening portion (92c, 93c, 192c, 193c, 292c, 293c, 393c) at which the communication hole opens in the outside surface of the main body portion (91, 191, 291, 391), and a connection surface (92b, 92d, 93b, 93d, 192b, 193b, 292b, 293b, 293d, 393d) which is formed continuously with the opening portion to have a band-shaped width so as to include a line that circulates on a plane that intersects a center line of the communication hole, and to which an oil passage (71, 72) of a body portion (61b, 161b) made of a synthetic resin and formed around the main body portion (91, 191, 291, 391) is connected; a blocking step of blocking the port by pressing a pin member (101, 201, 301) onto the connection surface; a filling step of filling the cavity with the molding material; and a take-out step of taking out a valve part that has the body portion (61b, 161b), which is molded from the molding material, and the spool housing (90, 190, 290, 390) from the mold. According to this configuration, the connection surface is formed so as to be continuous with the opening portion of the port of the spool housing (90, 190, 290, 390). Thus, formation of a gap between the pin member (101, 201, 301) and the opening portion of the port can be significantly suppressed, compared to a case where the opening portion of the port is formed on a curved surface, when the opening portion of the port is blocked by the pin member (101, 201, 301) during injection molding. Therefore, leakage of a molding material from the port into the spool housing (90, 190, 290, 390) during injection molding can be suppressed, and the spool (68p) of the valve after completion can be prevented from sticking because of a foreign matter that is the molding material which has leaked into and remains inside the spool housing (90, 190, 290, 390).

### INDUSTRIAL APPLICABILITY

The hydraulic control device for a vehicle power transfer device according to the present disclosure can be mounted on a vehicle etc., for example, and is particularly suitable for use for an automatic transmission that switches engagement elements etc. in accordance with supply and discharge of a hydraulic pressure.

1-19. (canceled)

20. A valve part comprising:
a body made of a synthetic resin; and
a spool housing provided separately from the body and embedded in the body, wherein:
the body is formed so as to surround the spool housing; and
the spool housing has:
a main body that has a hole that slidably houses a spool,
a port formed in a wall surface of the hole of the main body and configured to vary a state of communication between an inside and an outside of the main body in accordance with a position of the spool,
a communication hole that extends from the port toward a radially outer side,
a first projection in which the communication hole is formed and which is formed so as to project from an outside surface of the main body toward the radially outer side, and
a first opening at which the communication hole opens at a distal end of the first projection.

21. The valve part according to claim 20, wherein:
a material of the spool housing is a material with smaller dimensional variations than those of a material of the body;
a second opening is provided so as to be disposed at a different position from a position of the first opening in an axial direction of the main body;
the first projection is provided so as to be continuous in a circumferential direction from the first opening, and formed so as to project from the main body toward the radially outer side over an entire periphery; and
the spool housing has
a second projection provided so as to be continuous in the circumferential direction from the second opening, and formed so as to project from the main body toward the radially outer side over the entire periphery, and
a recess interposed between the first projection and the second projection in the axial direction and formed so as to be recessed over the entire periphery.

22. The valve part according to claim 21, wherein:
the body has an oil passage that communicates with the port; and
the spool housing has a connection surface which is formed continuously with the first opening to have a band-shaped width so as to include a line that circulates on a plane that intersects a center line of the communication hole, and to which the oil passage of the body is connected.

23. The valve part according to claim 22, wherein
the body includes an oil passage that communicates with each port and that has an opening end that tightly contacts the connection surface.

24. The valve part according to claim 22, wherein:
the connection surface has a first connection surface and a second connection surface;
the first connection surface is a flat surface disposed at an outer periphery of the opening; and
the second connection surface is a tapered surface formed to define the communication hole and graded with a port side of the second connection surface narrower than an opening side of the second connection surface.

25. The valve part according to claim 22, wherein
the connection surface is a tapered surface formed to define the communication hole and graded with a port side of the connection surface narrower than an opening side of the connection surface.

26. The valve part according to claim 25, wherein
the opening is formed so as to project from the outside surface of the main body toward the radially outer side.

27. The valve part according to claim 26, wherein:
an outer periphery of the opening is formed in a planar shape; and
a center line of the communication hole and the opening are orthogonal to each other.

28. The valve part according to claim 27, wherein
the main body is in a tubular shape.

29. The valve part according to claim 28, wherein
the port is in a perfect circle shape as viewed from an opening side.

30. The valve part according to claim 28, wherein
the port is in an oval shape as viewed from an opening side.

31. The valve part according to claim 30, wherein:
the port has at least two first ports; and
the at least two first ports are disposed on the same side of the main body in a first direction that is orthogonal to a center line of the main body, and the respective openings of the first ports are provided in parallel with each other.

32. The valve part according to claim 31, wherein:
the port has at least one second port; and
the at least one second port is disposed on the opposite side of the main body from the first ports in the first direction which is orthogonal to the center line of the main body, and the opening of the second port is provided in parallel with the openings of the first ports.

33. The valve part according to claim 32, wherein
the first ports and the second port are disposed alternately on the center line of the main body.

34. A valve part comprising:
a spool housing that has:
a main body made of metal and having a hole that slidably houses a spool,
a port formed in a wall surface of the hole of the main body and configured to vary a state of communication between an inside and an outside of the main body in accordance with a position of the spool,
a communication hole that allows communication between an outside surface of the main body and the port, and
an opening at which the communication hole opens in the outside surface of the main body; and
a body made of a synthetic resin, formed around the spool housing, and having an oil passage that communicates with the port, wherein
the spool housing has a connection surface which is formed continuously with the opening to have a band-shaped width so as to include a line that circulates on a plane that intersects a center line of the communication hole, and to which the oil passage of the body is connected.

35. The valve part according to claim 34, wherein
the connection surface is a flat surface disposed at an outer periphery of the opening.

36. The valve part according to claim 34, wherein
the connection surface is a tapered surface formed to define the communication hole and graded with a port side of the connection surface narrower than an opening side of the connection surface.

37. The valve part according to claim 34, wherein
the main body is in a rectangular parallelepiped shape.

38. The valve part according to claim 35, wherein
a plurality of the ports are provided, and each of flat surfaces corresponding to the ports has one opening.

39. A method of manufacturing a valve part, comprising:
tightening a die so as to form a cavity to be filled with a molding material at an outer periphery of a spool housing that has a main body that is made of metal and that has a hole that slidably houses a spool, a port formed in a wall surface of the hole of the main body and configured to vary a state of communication between an inside and an outside of the main body in accordance with a position of the spool, a communication hole that allows communication between an outside surface of the main body and the port, an opening at which the communication hole opens in the outside surface of the main body, and a connection surface which is formed continuously with the opening to have a band-shaped width so as to include a line that circulates on a plane that intersects a center line of the communication hole, and to which an oil passage of a body made of a synthetic resin and formed around the main body is connected;
blocking the port by pressing a pin onto the connection surface;
filling the cavity with the molding material; and
taking out the valve part that has the body, which is molded from the molding material, and the spool housing from the mold.
